(19) United States
(12) Patent Application Publication
(10) Pub. No.: US 2010/0266992 A1
(43) Pub. Date: Oct. 21, 2010

(54) INTERCHANGEABLE INSTRUMENT PANEL OVERLAY SYSTEM FOR A FLIGHT SIMULATOR

(75) Inventors: Jerry N. Gregoire, Austin, TX (US); Todd B. Willinger, Austin, TX (US); Jerry T. Gregoire, Austin, TX (US); Bradley J. Whitsitt, Indianapolis, IN (US); John Land, Austin, TX (US); Darren Bien, Austin, TX (US); Charles Gregoire, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: REDBIRD FLIGHT SIMULATIONS, INC., Austin, TX (US)

(21) Appl. No.: 12/425,355

(22) Filed: Apr. 16, 2009

(51) Int. Cl. G09B 9/08

(52) U.S. Cl. 434/38

(57) ABSTRACT

An interchangeable instrument panel overlay system for a flight simulator interchangeable with another simulating a different aircraft. Each instrument panel simulating a particular type of aircraft and containing switches, knobs, and/or buttons of approximately the same type and approximately the same location as in the simulated aircraft. The instrument panels capable of simulating a variety of avionics suites, gauges, and/or other equipment. The instrument panels capable of being affixed over a visual display displaying avionics suites, gauges, and/or other equipment.

### FIELD OF THE INVENTION

This invention pertains generally to simulators and more specifically to flight simulators.

### BACKGROUND OF THE INVENTION

The idea of using motion to enhance the flight simulation experience is nothing new. In fact, motion simulation has been used to train pilots since 1929. However, the expense, size, and power requirements of motion simulators has kept it largely out of reach of all but the largest training operations.

Existing commercial motion simulators are generally large, complex, and driven by hydraulics or pneumatics. The hydraulic and pneumatic solutions are loud, dirty, cumbersome, jerky, large, and require non-standard power. Furthermore, existing commercial motion simulators are prohibitively expensive.

Hydraulic drive systems provide motion by adding or removing fluid (normally hydraulic fluid or oil) in a hydraulic cylinder. When fluid is added, a piston is forced to move out of the hydraulic cylinder. Similarly, when fluid is removed, the weight of the piston (or the weight of what the piston is attached to) forces the piston back into the hydraulic cylinder. By adjusting the amount of fluid in the hydraulic cylinder, linear movement is achieved. Furthermore, hydraulic drive systems are dirty (because of the hydraulic fluid) and expensive.

Pneumatic drive systems work in a similar way to hydraulic drive systems except that instead of a fluid, air is used. An additional problem with pneumatic drive systems lies in the fact that air is highly compressible. Therefore, when weight is added or removed from the motion simulator (e.g. a user enters the motion simulator), the air in the pneumatic cylinders is compressed causing the motion simulator to move unexpectedly and become unstable and/or uncalibrated. Furthermore, the sound of air constantly being added and removed from the pneumatic cylinders is a constant distraction and interferes with a potentially immersive experience. As with hydraulic solutions, the resulting motion is also jerky and generally unresponsive.

Both pneumatic and hydraulic drive systems are also very large because the range of motion is determined by the throw of the piston. Therefore, if three feet of movement is desired, the cylinder itself must be at least three feet long and there must also be clearance for the piston to extend. This requires a minimum of six feet of clearance to achieve only a three foot movement.

At least one flight simulator utilizes high power electric motors as a means to provide motion. These simulators use long actuators attached to the electric motor. In response to the motors, one or more actuators are driven a few inches in a particular direction. The inherent problems of this design are similar to those in previous flight simulators. To obtain six degrees of freedom, requires six motors. Furthermore, very strong and high power motors are required to directly lift the cockpit. This raises the cost of the simulator and increases its power requirements. Furthermore, the cockpit must be placed several feet in the air to accommodate the large motors, power equipment to drive the motors, and the actuators themselves. Also, only very small movements, on the order of four to eight inches, are possible. With such small movements, the total deflection in any particular direction is relatively small and compromises the overall reality of the flight simulator.

Also, an additional significant deficiency of the current flight simulators is there inability to realistically simulate more than one model of aircraft. Each of the flight simulators is designed to mimic only one aircraft. In order to simulate multiple aircrafts, multiple simulators must be purchased. This makes owning multiple aircraft simulators cost and space prohibitive.

Yet another deficiency of the current flight simulators is the inability to both track and restrict the use of the simulator without constant supervision. Existing simulators require physical locks and/or supervision to restrict the simulators use to only authorized pilots. This requires additional personnel to police and log every pilot's simulator use. Furthermore, existing simulators require constant oversight to ensure the student pilot is only practicing approved missions that compliment the student pilot's education and competency level.

Therefore, there is a need for a flight simulator that overcomes the deficiencies and shortcomings of existing simulators.

### BRIEF SUMMARY OF THE INVENTION

The disclosed subject matter includes an interchangeable instrument panel overlay system for a flight simulation system.

A technical advantage of the present invention is providing a realistic instrument panel simulating a particular aircraft that is interchangeable with another instrument panel simulating another aircraft.

Another technical advantage of the present invention is simulating multiple types and styles of avionics suites.

An additional technical advantage of the present invention is an instrument panel having buttons, switches, and knobs of approximately the same type and in approximately the same location as the particular simulated aircraft to enhance realism and increase training effectiveness.

Yet another technical advantage of the present invention is having avionics, gauges, and other equipment simulated on visual displays.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The novel features believed characteristic of the invention are set forth in the claims. The invention itself, however, as well as a preferred mode of use, further objectives, and advantages thereof, will best be understood by reference to the following detailed description of illustrative embodiments when read in conjunction with the accompanying drawings, wherein:

FIG. 1 illustrates a computer system and related peripherals that may operate with the present invention.

FIG. 2 depicts a screen capture of the start screen of the administrator software.

FIG. 3 depicts a screen capture of the manage pilot records and pilot keys screen of the administrator's console.

FIG. 4 depicts a screen capture of the manage pilot screen of the administrator's console.

FIG. 5 depicts a screen capture of the pilot's flight history screen of the administrator's console.

FIG. 6 depicts a screen capture of the select mission scenarios for the pilot screen of the administrator's console.

FIG. 7 depicts a screen capture of the manage training missions screen of the administrator's console.

FIG. 8 depicts a screen capture of the reports screen of the administrator's console.

FIG. 9 depicts a screen capture of the flight history by date screen of the administrator's console.

FIG. 10 depicts a screen capture of the flight history by pilot screen of the administrator's console.

FIG. 11 depicts a screen capture of the export data to file screen of the administrator's console.

FIG. 12 depicts a high level overview of the acrylic overlay.

FIGS. 13a and 13b depict schematic diagrams for two PCBs that would be attached to an acrylic panel in one embodiment.

FIGS. 13c and 13d depict schematic diagrams for two PCBs that would be attached to an acrylic panel in an alternative embodiment.

FIGS. 13e, 13f, and 13g depict a front view, front isometric view, and rear isometric view, respectively, of an acrylic panel in one embodiment.

FIGS. 13h, 13i, and 13j depict a front view, front isometric view, and rear isometric view, respectively, of an acrylic panel in an alternative embodiment.

FIGS. 13k, 13l, and 13m show pictures of the PCBs attached to the acrylic with nylon screws, with rotary encoders and push buttons but without knobs and caps, and with knobs and caps, respectively.

FIG. 13n shows pictures of the fully assembled acrylic panel attached over the virtual instrumentation displays.

FIG. 14 depicts a basic block diagram of the information flow of the acrylic overlay.

FIGS. 15a and 15b show an isometric and front view, respectively, of the rudder pedals.

FIGS. 15c and 15d show an isometric and front view, respectively, of the rudder pedals with the top, side, and bottom covers removed.

FIGS. 16a and 16b show an isometric and top view, respectively, of a single engine throttle quadrant without the top cover or front cover.

FIGS. 17a and 17b show an isometric and top view, respectively, of an alternate embodiment of the throttle quadrant without the top cover or front cover.

FIGS. 17c and 17d show an isometric and top view of the alternate embodiment of the throttle quadrant including the top cover and front cover installed.

FIGS. 18a and 18b show isometric and top views, respectively, of the yoke assembly.

FIG. 19 depicts the yoke and throttle quadrant installed in the cockpit.

FIG. 20a shows an isometric view from the front right corner of the motion platform.

FIG. 20b depicts a right side view of the motion platform.

FIG. 20c depicts an isometric view from the rear right corner of the motion platform.

FIG. 20d depicts a rear view of the motion platform.

FIG. 20e depicts a left side view of the motion platform.

FIGS. 20f and 20g show pictures of the infrared transmitter and reflector, respectively, of the preferred embodiment.

FIG. 21 depicts a screen capture of the map screen for the instructor software.

FIG. 22 depicts a screen capture of the relocate screen for the instructor software.

FIG. 23 depicts a screen capture of the weather screen for the instructor software.

FIG. 24 depicts a screen capture of the failures screen for the instructor software.

FIG. 25 depicts a screen capture of the opening screen for the pilot software.

FIG. 26 depicts a screen capture of the invalid key screen for the pilot software.

FIG. 27 depicts a screen capture of the mission select screen for the pilot software.

FIGS. 28a and 28b depict screen captures of the system passing and failing the self-check, respectively, for the pilot software.

FIG. 29 depicts a screen capture of the start motion platform query for the pilot software.

FIG. 30 depicts a flow diagram for the motion platform interface.

FIG. 31 depicts a flow chart of the routine operation of the motion platform firmware.

FIG. 32 depicts the platform control system of the preferred embodiment.

FIG. 33 depicts a cross sectional view of the corrugated aluminum of the preferred embodiment.

FIG. 34 shows an exemplary cockpit of the preferred embodiment.

FIG. 35 depicts the visual displays showing simulated external views of the preferred embodiment.

FIG. 36a depicts the interchangeable instrument panel affixed over visual displays displaying the instruments customarily found in an aircraft with glass panel instrumentation of one embodiment.

FIG. 36b depicts the interchangeable instrument panel affixed over visual displays displaying the more traditional six pack and avionics stack of an alternative embodiment.

### DETAILED DESCRIPTION OF ILLUSTRATIVE EMBODIMENTS

Those with skill in the arts will recognize that the disclosed embodiments have relevance to a wide variety of areas in addition to those specific examples described below. All references, including publications, patent applications, and patents, cited herein are hereby incorporated by reference to the same extent as if each reference were individually and specifically indicated to be incorporated by reference and were set forth in its entirety herein.

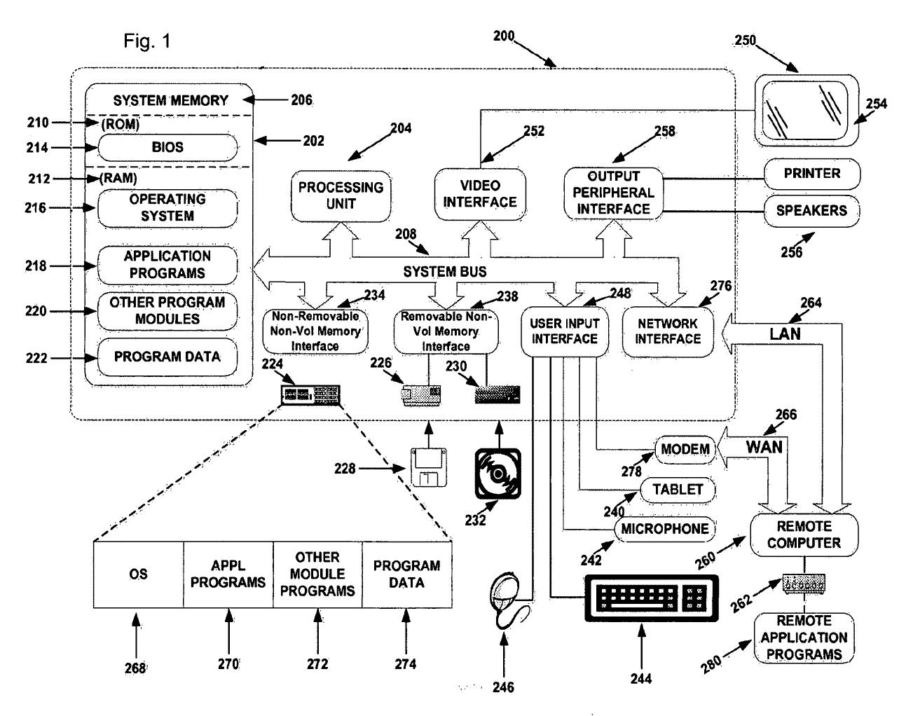

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

### Administrator Software

The administrator software is loaded onto a standard desktop computer at the flight school. The administrator software operates with a Microsoft® (a registered trademark of Microsoft Corporation) SQL server back end and manages the records and training scenarios for each student pilot at the flight school. Although the preferred embodiment utilizes Microsof® SQL, any database program could be implemented.

Administrator's console

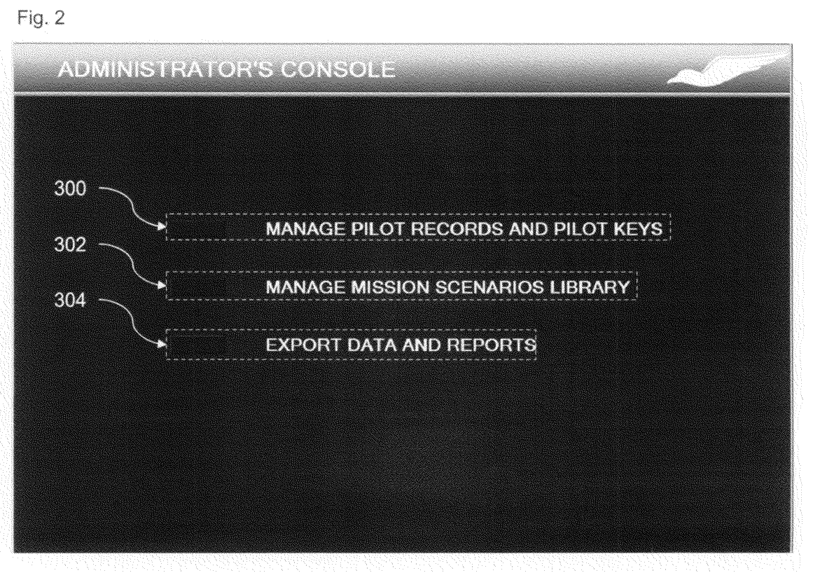

FIG. 2 depicts a screen capture of the start screen of the administrator software—also called the administrator's console. The administrator's console provides a user three choices: manage pilot records and pilot keys 300, manage mission scenarios 302, and provides data export and reporting functionality 304. Each will be discussed in greater detail below.

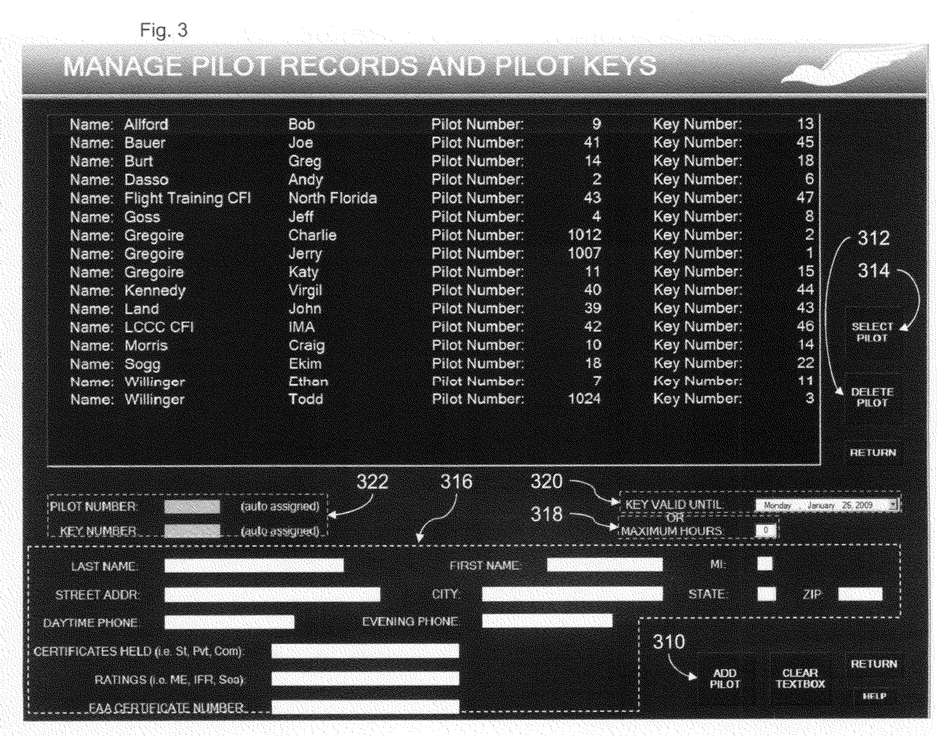

FIG. 3 depicts a screen capture of the manage pilot records and pilot keys screen. Once a user selects to manage pilot records and pilot keys, the user may: add a new student pilot 310, delete an existing student pilot 312, or select a student pilot 314. The add and delete functions prompt the user to confirm their actions.

To delete a pilot, the pilot's name is selected from the list of available pilots and then the delete pilot button 312 is pressed. In the preferred embodiment, when a pilot is deleted, all flight history information for the pilot is also deleted. However, in an alternative embodiment, the flight history could be saved for later retrieval (i.e. the student pilot returns to the flight school and resumes training).

To add a pilot, the user would enter the pilot's information in the fields 316. The pilot information could include name, address, phone numbers, certificates held (student pilot, recreational pilot, private pilot, commercial pilot, airline transport pilot, etc.), certificate number, and ratings (instrument, multiengine, etc.). In addition to the pilot's information, either the maximum number of hours the pilot is authorized to use the flight simulator 318 or the expiration date of the pilot's authorization to use the flight simulator 320 is entered by the user. Finally, the user is added to the database with the add pilot 310 button. The pilot number and the key number 322 are auto generated by the software.

To manage a particular pilot, the user would select that pilot form the list of pilots, and use the select pilot button 314.

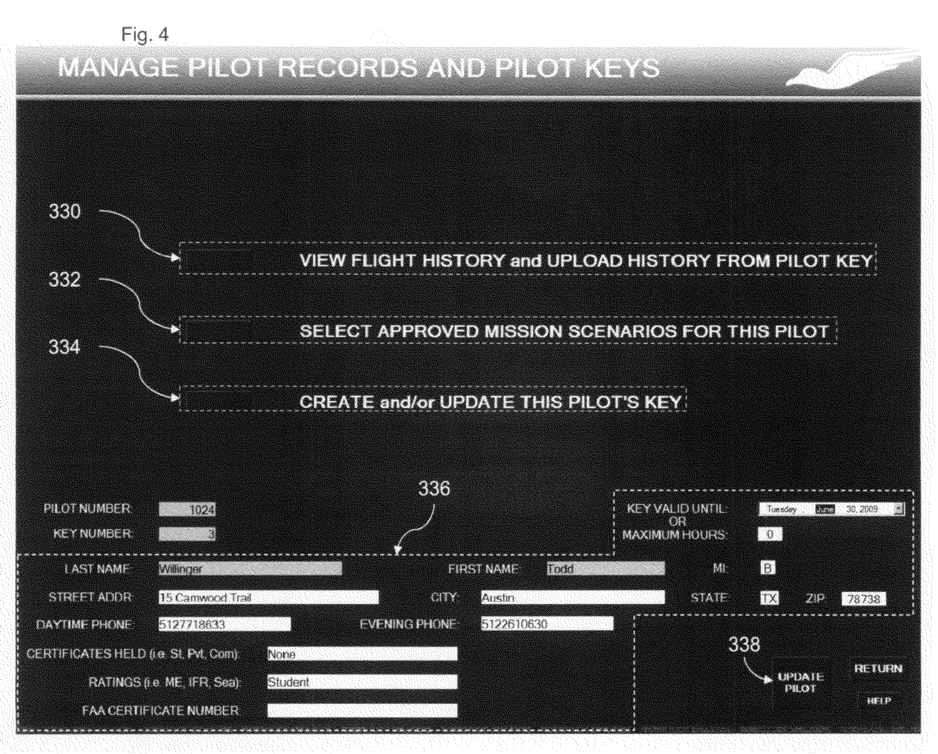

FIG. 4 depicts a screen capture of the manage pilot screen. The manage pilot screen gives the user three options: view flight history and upload history from pilot key 330, select approved mission scenarios for this pilot 332, and create and/or update this pilot's key 334. Also, the pilot's information is provided and can be modified 336. If the user updates any of the pilot's information, the user need only press the update pilot button 338 to save the new information.

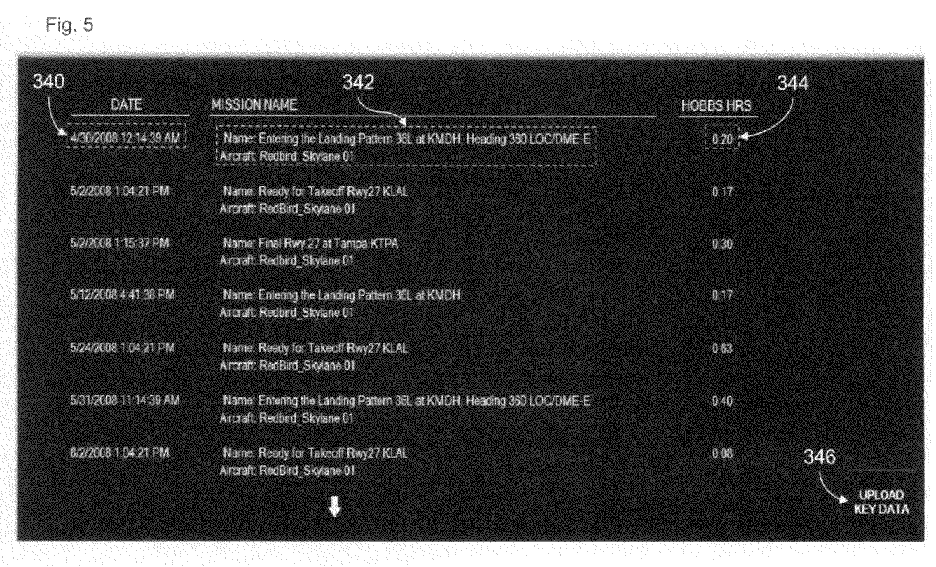

FIG. 5 depicts a screen capture of the pilot's flight history screen. When the user selects the view flight history button 330, the user is shown the flight history screen. The flight history screen lists all of the flights the student pilot has flown and the corresponding data uploaded from the student pilot's pilot key to the administrator's computer. The flight history information includes, among other things, the time and date the training scenario or mission was completed 340, the name of the training scenario 342, and the length of time for the training scenario 344. In the preferred embodiment, inserting the pilot's pilot key at the flight history screen will automatically update the pilot's flight history. Additionally, if the pilot's pilot key was previously inserted, the flight history may be updated by pressing the update keydata button 346.

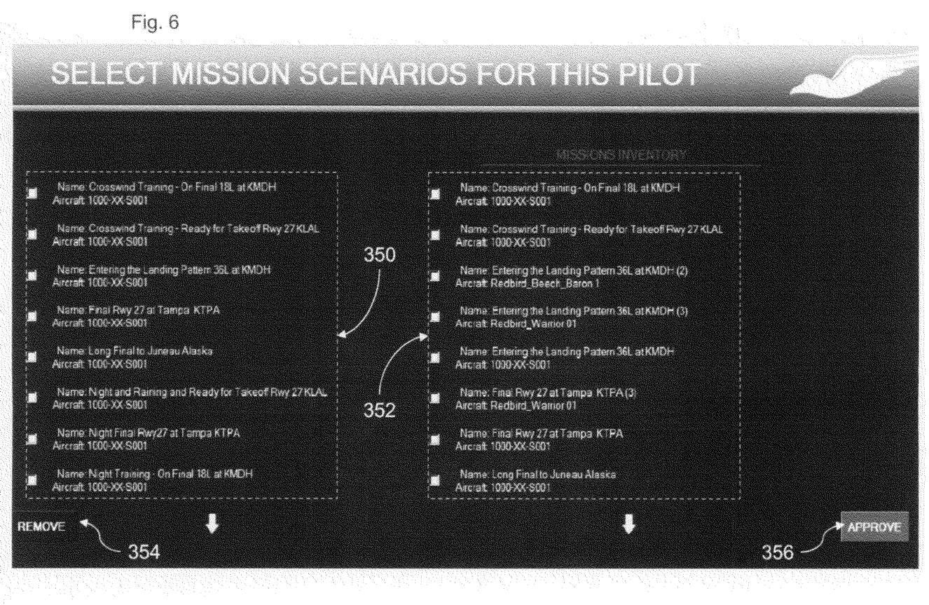

FIG. 6 depicts a screen capture of the select mission scenarios for this pilot screen. This screen allows the user to add or remove the training scenarios the student pilot is allowed to fly. The missions inventory 352 shows all of the flight schools missions; whereas, the approved missions 350 lists only those missions for which the student pilot is allowed to fly. To remove an approved mission, the user would select the mission to be removed, and press the remove button 354. To add a mission to the approved mission, the user selects the mission to be approved and presses the approve button 356. In the preferred embodiment the user may select multiple missions to be added or removed at the same time. Once the pilot's pilot key is rebuilt, the student pilot will only be permitted to fly the approved missions. This allows an administrator to tailor a particular student pilot's training and ensure the student pilot is unable to attempt missions beyond the student pilot's skill set.

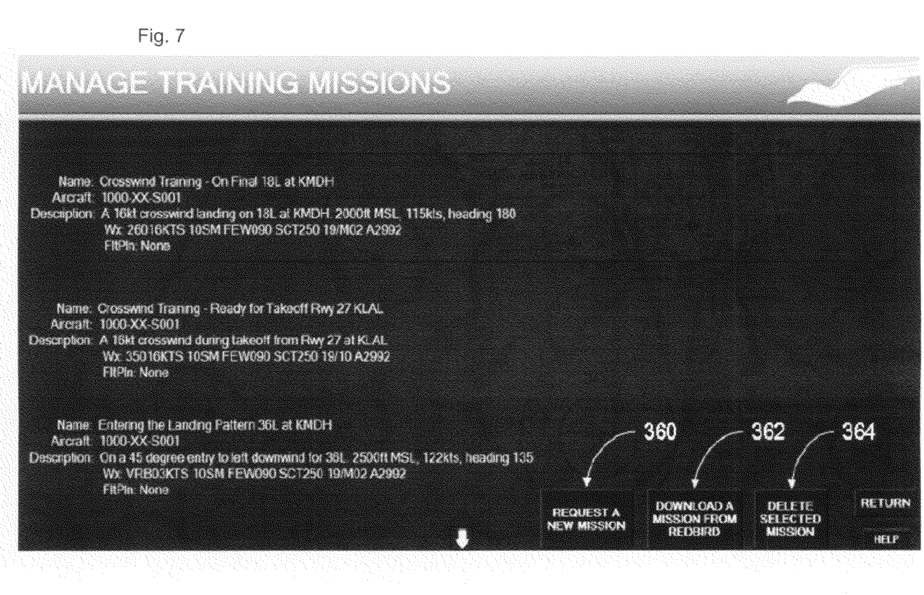

FIG. 7 depicts a screen capture of the manage training missions screen. The user may request a new mission 360, download a mission 362, or delete a mission 364. In the preferred embodiment, the software would come pre-loaded with several missions; however, additional missions could be added later. When the user presses the request a new mission button 360, a web browser is launched and the user is directed to a website where the user may enter information regarding the training scenario they would like created. In the preferred embodiment, the website would require authentication (i.e. login credentials) prior to allowing the user to request a training scenario be created.

When the user presses the download a mission button, a web browser is launched and the available training missions are provided for download. In the preferred embodiment, the website would require authentication (i.e. login credentials) prior to displaying the list of missions available for download or allowing the user to download missions. In the preferred embodiment, once the user has selected the desired mission to be downloaded, an MSI package is downloaded to the administrator's computer. The user would install the mission into the software by double clicking the downloaded MSI package.

Finally, if the user wanted to delete a mission from the database, the user would select the mission and press the delete selected mission button 364.

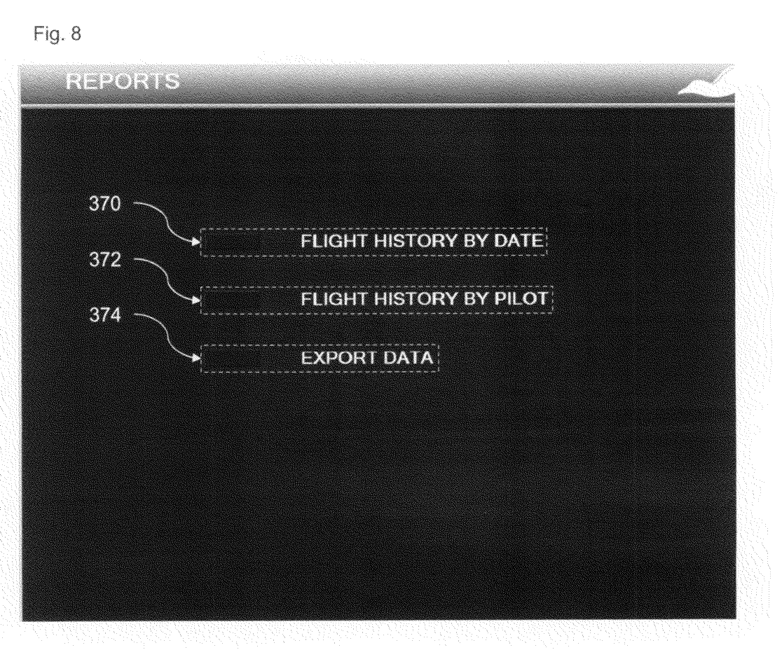

FIG. 8 depicts a screen capture of the reports screen. The user may generate reports of flight history by date 370 or by pilot 372 and may export data 374. The flight history by date button 370 takes the user to the flight history by date screen.

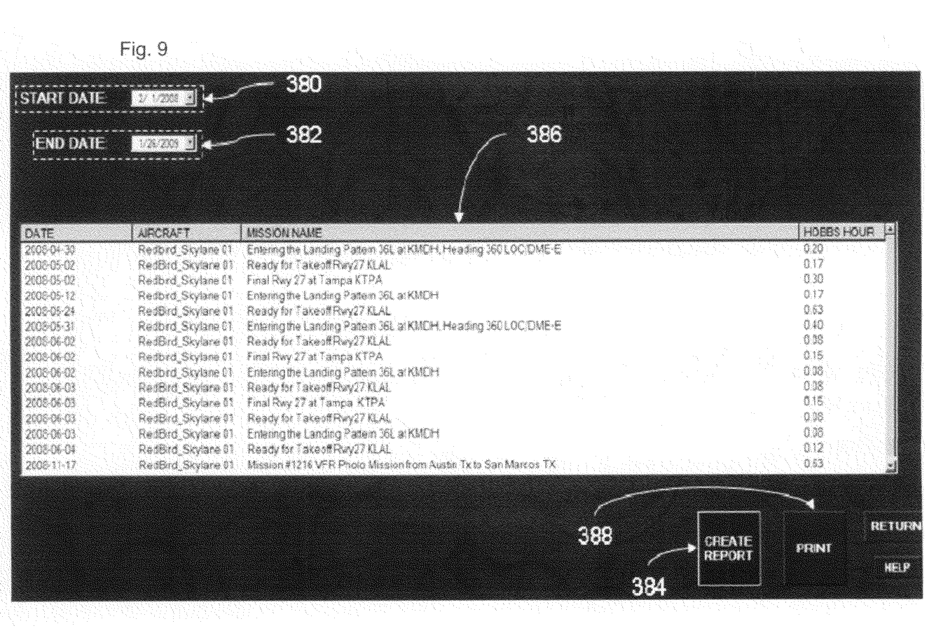

FIG. 9 depicts a screen capture of the flight history by date screen. The user first selects the date range of the desired report by entering the start date 380 and the end date 382. The user then presses the create report button 384 and all flights flown in the flight simulator that have been uploaded to the administrator's computer within the date range are displayed. The user may review the report on screen 386 or print the report by pressing the print button 388. In the preferred embodiment, Crystal Reports® (a registered trademark of Seagate Software, Inc.) is utilized to provide the user interactive reports; however, other methods and reporting software could be utilized.

FIG. 10 depicts a screen capture of the flight history by pilot screen. The user selects one or more pilots from the pilot listing 390 (or selects all pilots 392) and then presses the create report button 394. All flights flown by the selected pilot(s) that have been uploaded to the administrator's computer within the date range are displayed on the screen 396. Additionally, the user may print the report by pressing the print button 398. In the preferred embodiment, Crystal Reports® (a registered trademark of Seagate Software, Inc.) is utilized to provide the user interactive reports; however, other methods and reporting software could be utilized.

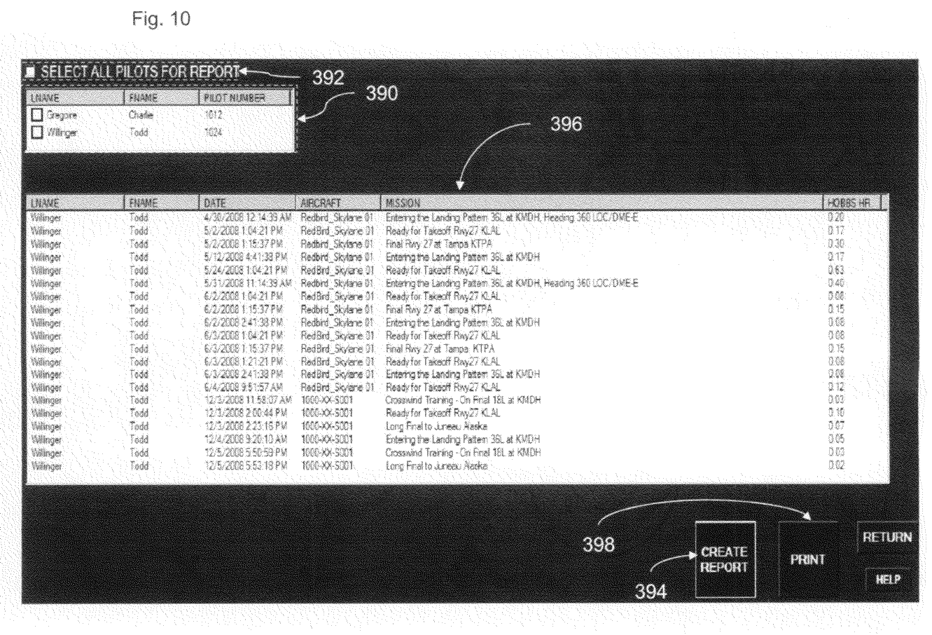

FIG. 11 depicts a screen capture of the export data to file screen. The user may export pilot record information 400 or export pilot flight history information 402. By pressing the export pilot record information button 400, a comma separated value (“CSV”) file is produced containing all entered and uploaded information about all pilots. This would include the pilot's information (name, address, phone number, certifications, ratings, etc.). By clicking on the export pilot flight history information button 402, a CSV file is generated containing all of the flight history entered and uploaded for all pilots (pilot's name, date and time the mission was flown, name of mission, total flight time, etc.). The benefit of exporting data to a CSV file is the data is then easily manipulated and imported by other programs including spreadsheet and/or billing programs.

### Acrylic Overlay

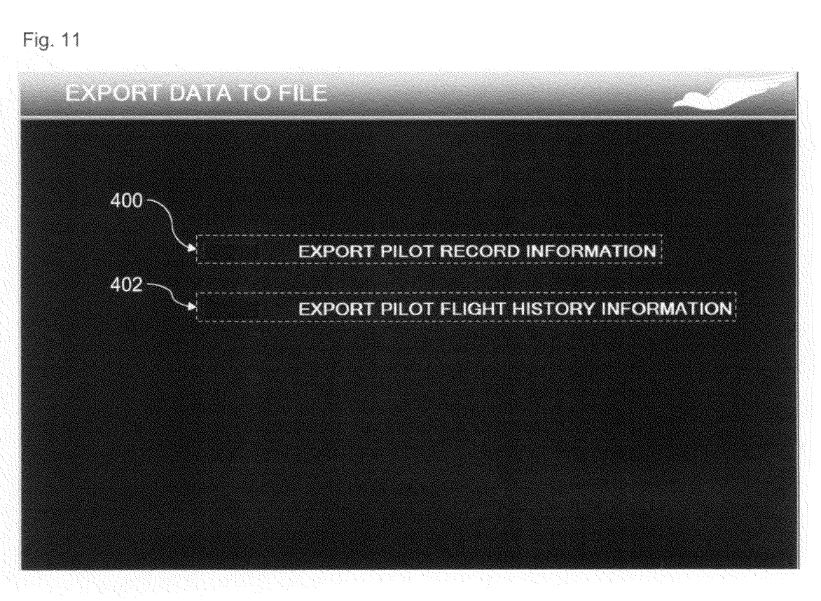

FIG. 12 depicts a high level overview of the acrylic overlay. The acrylic overlay 410 is composed of five major divisions: human interface—buttons, caps, and knobs 412; acrylic 414; printed circuit boards (“PCB”) 416; firmware—PIC microcontroller on PCB 418; and the blind mating connector 420. Additionally, by means of the blind mating connector 420, the PC 426 provides the virtual instrumentation displays 422 and the ESP engine/.NET software 424.

The human interface 412 portion contains the knobs and caps that would otherwise appear in the aircraft being simulated and are placed on the acrylic in a position that closely approximates the position of the knob or cap in the aircraft being simulated. The purpose of the knobs and caps is to provide the student pilot a way to interact with the aircraft's gauges and avionics. In the preferred embodiment, the knobs and caps are the same or close analogs of the actual knobs and caps that appear in the aircraft being simulated.

The acrylic 414 is a thin piece of acrylic panel (about ⅝ of an inch thick) that has portions of the acrylic removed to allow rotary encoders and push buttons to pass through the acrylic 414 and be populated. In the preferred embodiment, a CNC router is used to make the cut-outs.

The PCBs 416 are designed to represent various aircraft configurations such as avionics, gauges, etc. The rotary encoders and momentary switches provide a realistic facsimile of an aircraft and are used to provide a student pilot a way to interact with the different aircraft controls. In the preferred embodiment, the PCBs 416 are attached to the acrylic 414 with nylon screws.

The firmware 418 gathers all of the student pilot's inputs from the various knobs, switches, caps, and other devices attached to the PCBs 416 and sends the information to an attached PC 426 via the blind mating connector 420. In the preferred embodiment, this information is collected by a PIC 2550 microcontroller through shift register chain polling. Further, in the preferred embodiment, the blind mating connector 420 is a USB style connector that connects to a cable attached to the PC 426 such that when the acrylic overlay 410 is attached via the mounting posts, the blind mating connector 420 is coupled to the cable attached to the PC 426 without further user intervention.

The virtual instrumentation displays show the student pilot the various aircraft gauges and avionics. These gauges and avionics are updated in response to the student pilot's actuation of the various controls on the acrylic (and the other control interfaces disclosed herein). In the preferred embodiment, the virtual instrumentation displays are liquid crystal displays (“LCDs”). The LCDs are positioned behind the acrylic overlay 410 such that portions of the LCDs are viewable through the acrylic 414. This allows the gauges and avionics to be displayed on the LCDs and be seen by the student pilot. As briefly mentioned earlier, the various knobs, switches, caps, and other devices are oriented in a manner so as to closely approximate there location in the aircraft being simulated and to correspond to their real life positions in relation to the gauges and avionics displayed on the LCDs.

Finally, the ESP engine/.NET software 422 running on the PC 426 receives the information from the PCBs 416 updates the data structures in the ESP engine and transmits events based on the student pilot's actions to the LCDs (and other apparatuses, if connected).

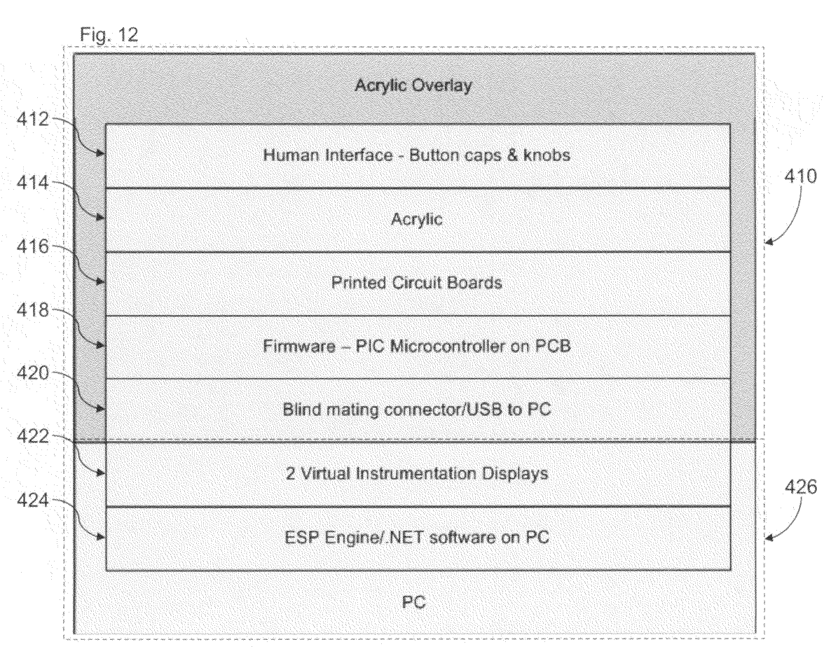

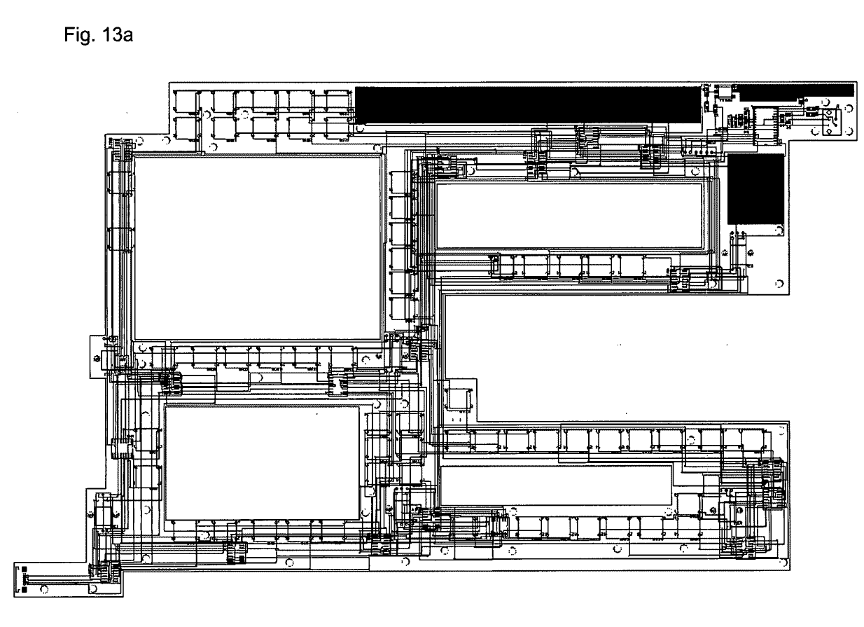

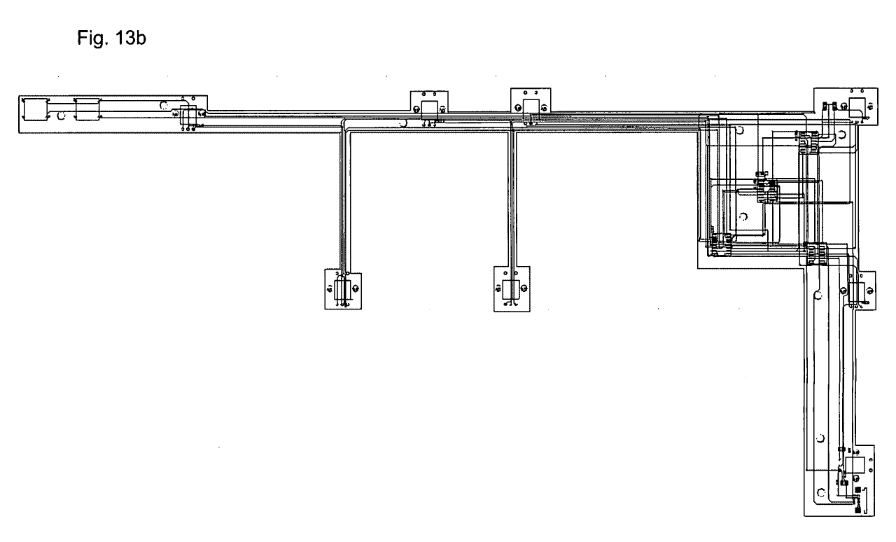

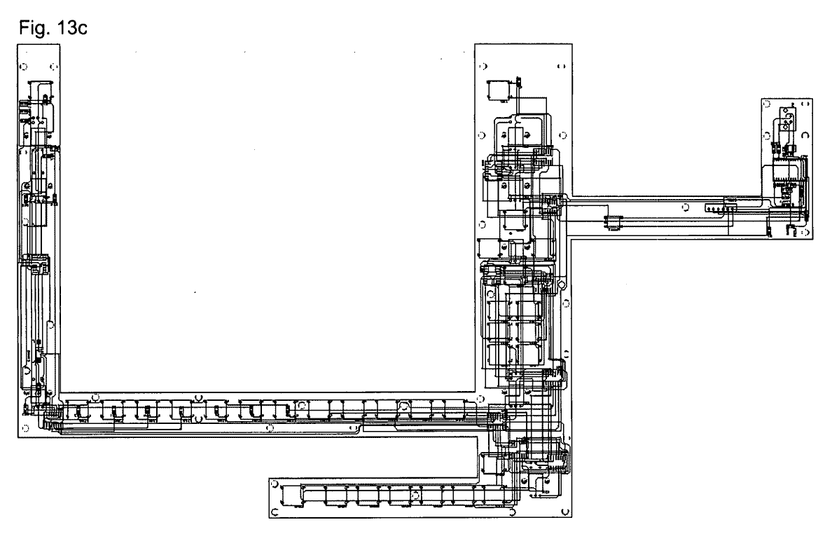

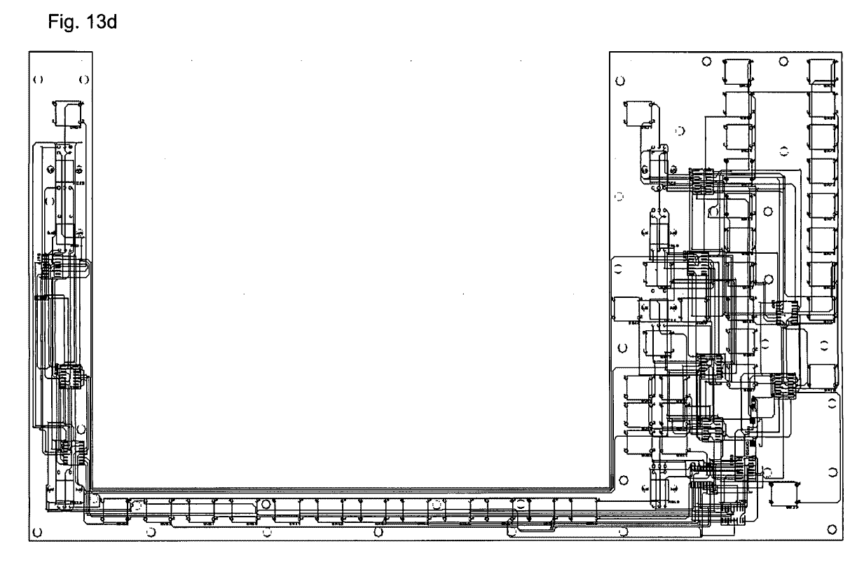

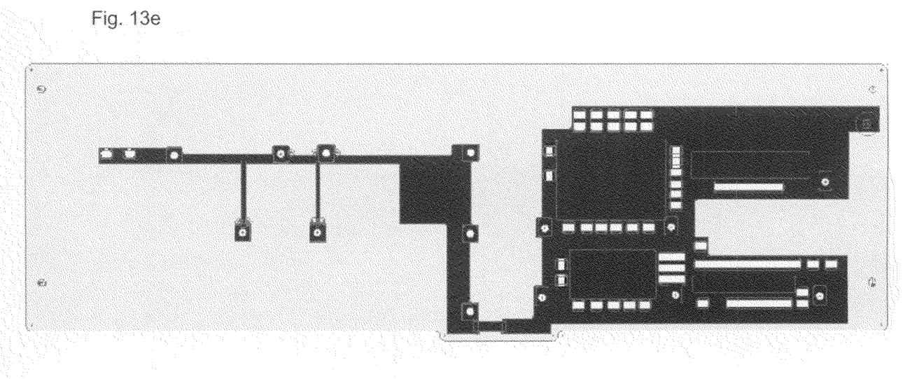

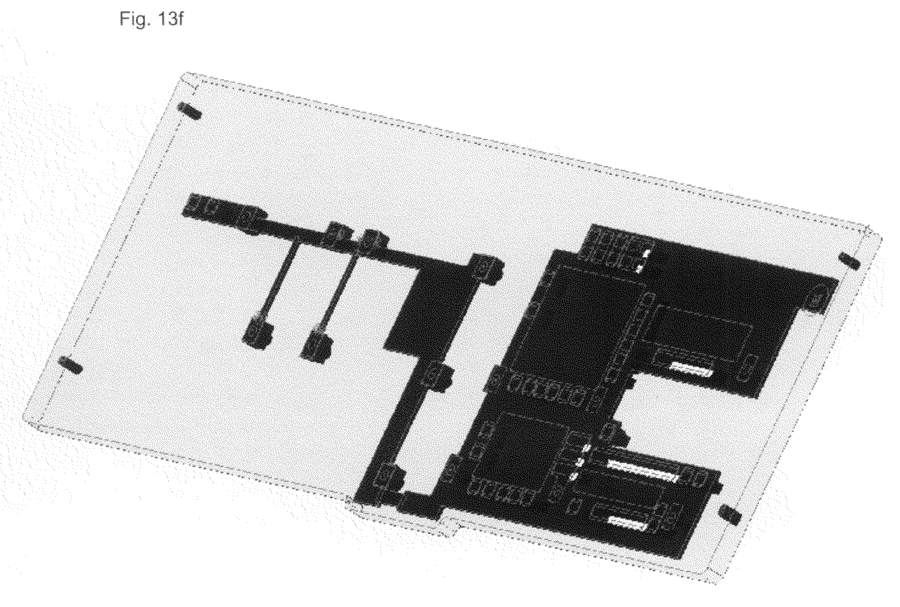

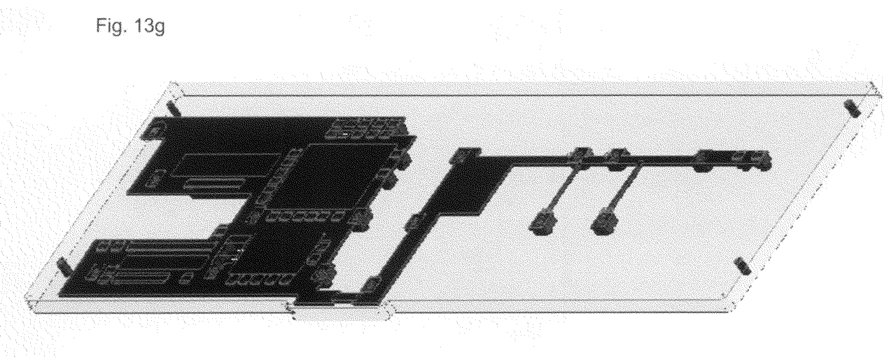

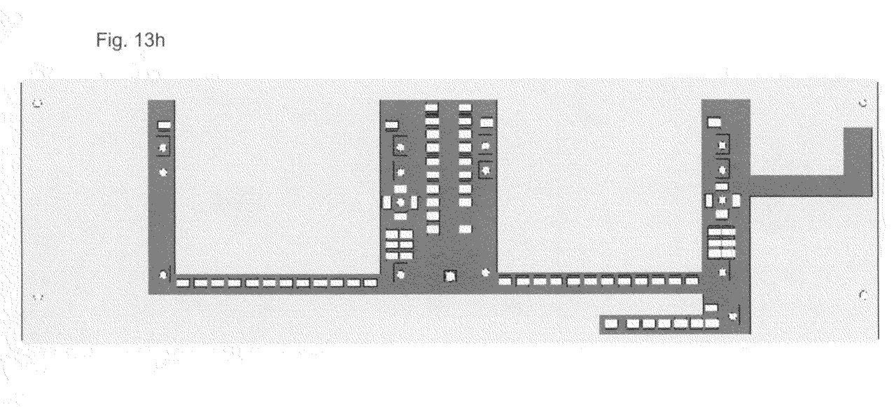

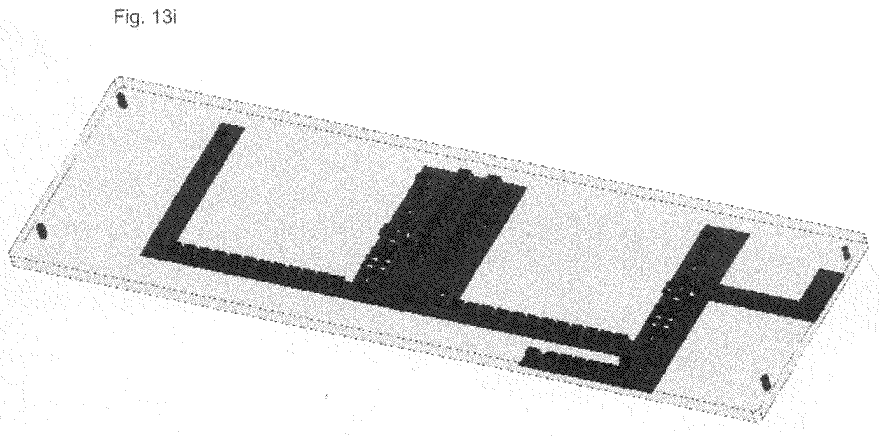

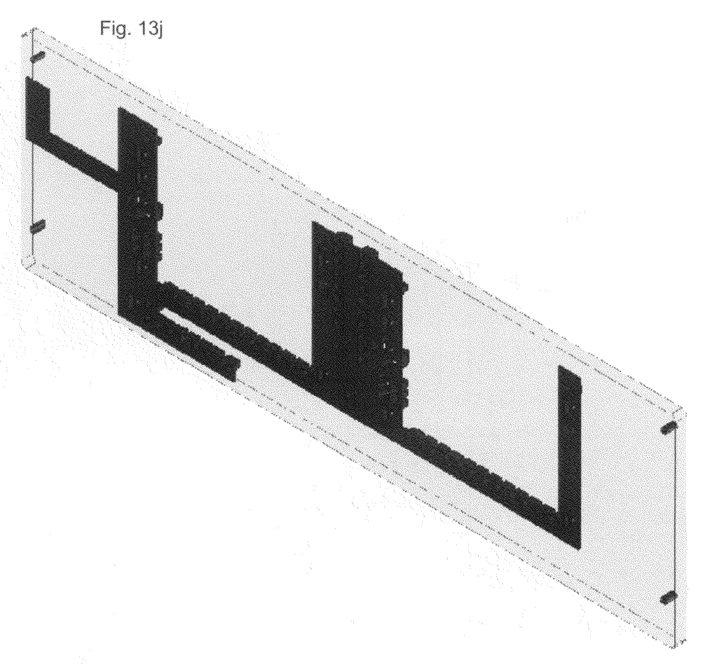

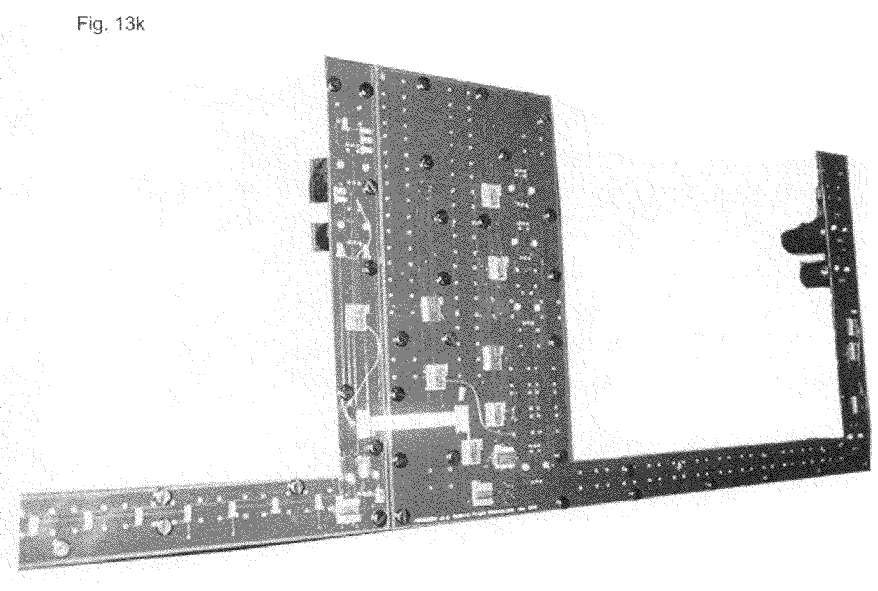

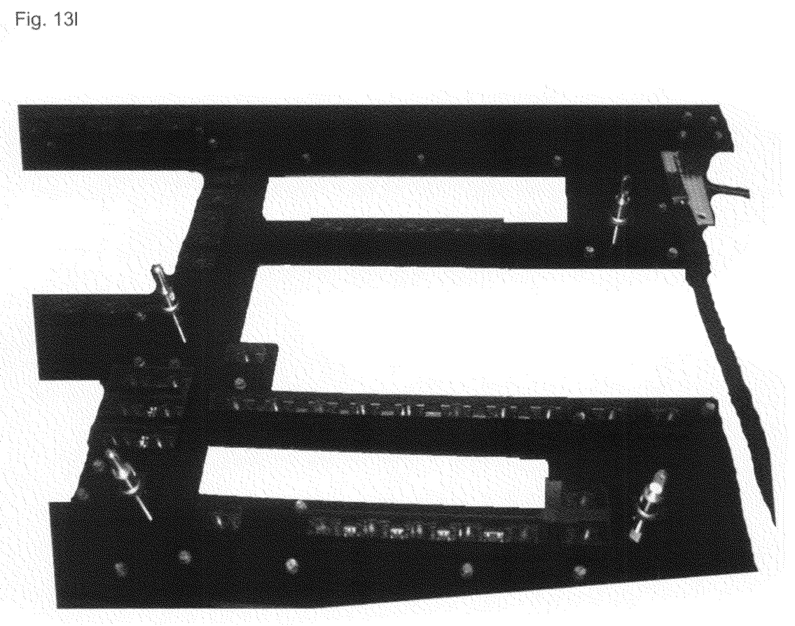

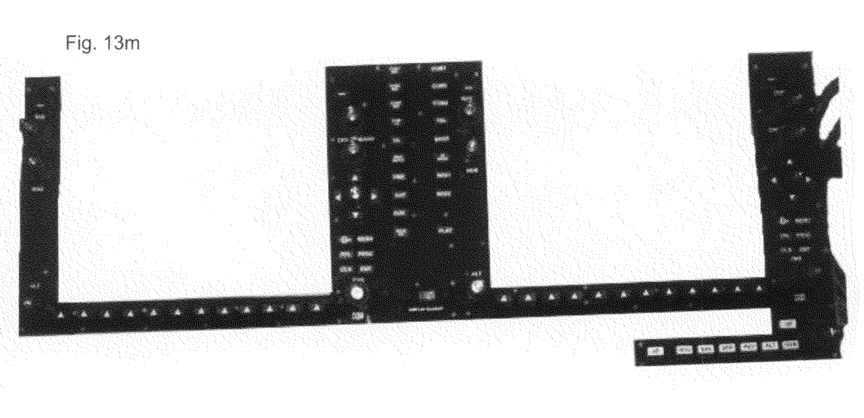

FIGS. 13a-13n depict exemplary images and schematics of the acrylic overlay. FIGS. 13a and 13b depict schematic diagrams for two PCBs that would be attached to an acrylic panel in one embodiment (simulating the standard six pack and avionics stack of a traditional aircraft). FIGS. 13c and 13d depict schematic diagrams for two PCBs that would be attached to an acrylic panel in an alternative embodiment (simulating an all glass avionics suite similar to the G1000 (a registered trademark of Garmin International, Inc.)). FIGS. 13e, 13f, and 13g depict a front view, front isometric view, and rear isometric view, respectively, of an acrylic panel in one embodiment (simulating the standard six pack and avionics stack of a traditional aircraft). FIGS. 13h, 13i, and 13j depict a front view, front isometric view, and rear isometric view, respectively, of an acrylic panel in an alternative embodiment (simulating a glass avionics suite). FIGS. 13k, 13l, and 13m show pictures of the PCBs attached to the acrylic with nylon screws, with rotary encoders and push buttons but without knobs and caps, and with knobs and caps, respectively. Finally, FIG. 13n shows pictures of the fully assembled acrylic panel attached over the virtual instrumentation displays.

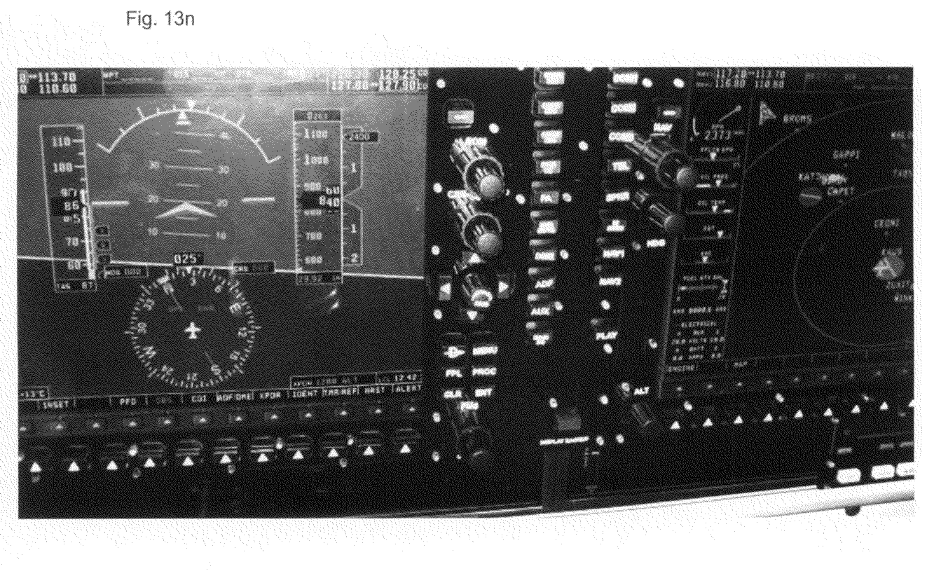

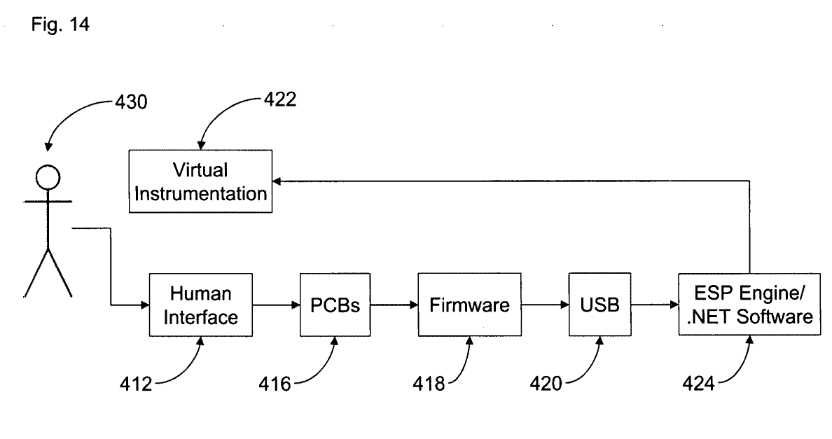

FIG. 14 depicts a basic block diagram of the information flow of the acrylic overlay 410. The student pilot 430 actuates one or more of the human interface devices 412 which is received by the PCB 416 and in turn the firmware 418 transmits the information received by the PCB 416 to the ESP engine/.NET software 424 via the blind mating connector 420 (and possibly a USB cable). The ESP engine/.NET software then interprets the information and changes the virtual instrumentation displays 422 to account for the student pilot's 430 action(s).

### Rudder Pedals

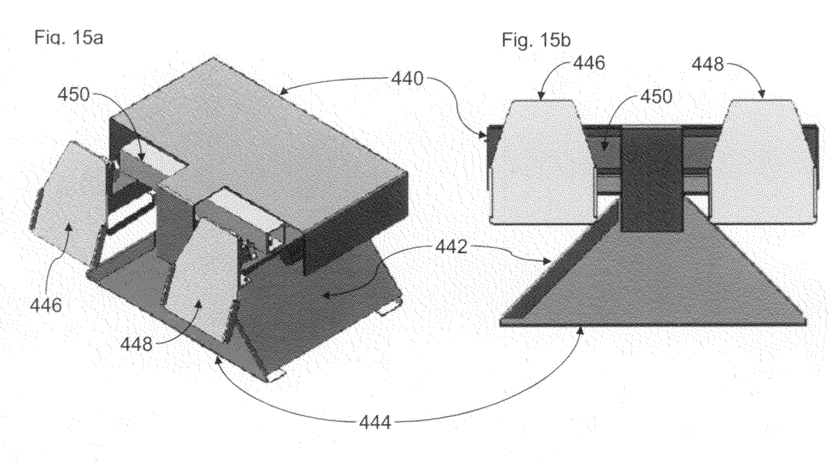

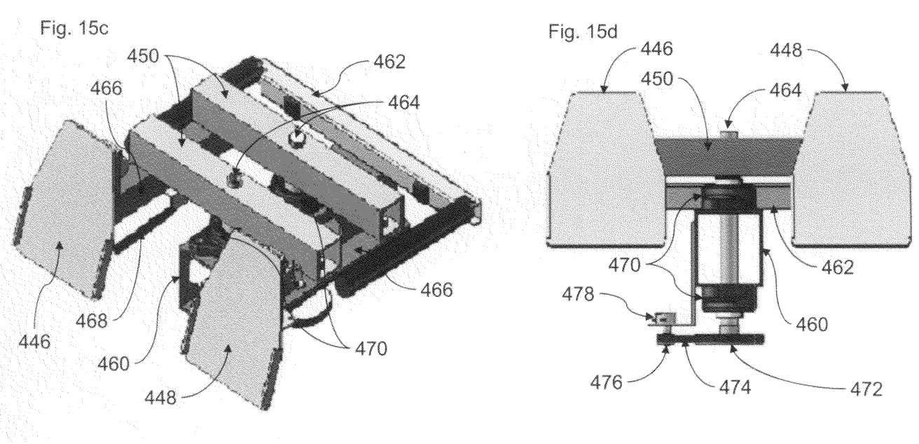

FIGS. 15a and 15b show an isometric and front view, respectively, of the rudder pedals. In an actual aircraft, the rudder pedals are used to control the rudder. The rudder is a control surface that imparts yaw and compensates for adverse yaw. The rudder pedals in a flight simulator are similar, except that they do not directly control an actual rudder but send signals of any movement to a software program that interprets the signals and adjusts any visual or physical cues in response to the movement.

Referring to FIG. 15a, the left rudder pedal 446 and right rudder pedal 448 are each coupled to a pedal support 466. The pedal supports 466 are coupled to one or more cross beams 450. The cross beams 450 are coupled to the main housing (not shown) in such a manner that when one rudder pedal is pushed in, the other pedal moves out. Springs 468 are used to return the rudder pedals 446 and 448 to an equilibrium position. A top 440, side 442, and bottom cover 444 generally enclose the moving parts. Referring now to FIG. 15b, the travel stop 462 physically stops the cross beams 450 from traveling too far. The interference with the travel of the cross beam 450 consequently stops the rudder pedals 446 and 448 and the pedal supports 466 from over travel.

FIGS. 15c and 15d show an isometric and front, respectively, of the rudder pedals with the top, side, and bottom covers removed. In FIG. 15c, it is easier to see the relationship between the rudder pedals (446 and 448), the pedal supports 466, the cross beams 450, the travel stop 462, and the springs 468. The shafts 464 are used to provide rotational coupling from the cross beams 450 to the main body 460. The shafts 464 are threaded through bushings 470 to provide smooth movement of the rudder pedals (446 and 448). The bushings 470 are attached to the main body 460. FIG. 15d provides another angle to show a shaft 464 traveling through a cross beam 450, a bushing 470, the main body 460, and another bushing 470. Finally, the shaft 464 is coupled to a shaft pulley 472 which is coupled to a pot pulley 476 via a belt 474. The pot pulley 476 is coupled to a potentiometer 478 which is used to measure the amount of deflection of the rudder pedals (446 and 448). This deflection information is then transmitted to a computer for analysis and action. An alternative embodiment includes a braking mechanism, on either the top or bottom of the rudder pedals (446 and 448), depending on the aircraft being simulated, either a sensor to sense when the top (or bottom) of the rudder pedals are pressed or an additional pivoting portion on the top (or bottom). As yet another embodiment, force feedback and/or haptic feedback could be employed to enhance the realism of the simulator. As an example, as an aircraft is taxiing and a gust of wind impacts the aircraft, a pilot in a real aircraft could feel the impact of the wind on control surfaces (e.g. rudder, elevator, ailerons) through the yoke and rudder pedals. As an additional example, when taxiing, a tricycle geared airplane (as opposed to a tail dragger) the front direction of the front wheel is adjusted using the rudder pedals. As with any wheel, when the wheel is not moving and has weight on it, the wheel is difficult to move. Force feedback could be used to simulate the difficulty of moving the wheel when a plane was stopped and be adjusted as the plane began to move. By implementing force feedback or haptic feedback, additional realism could be employed in the simulator.

### Throttle Quadrant

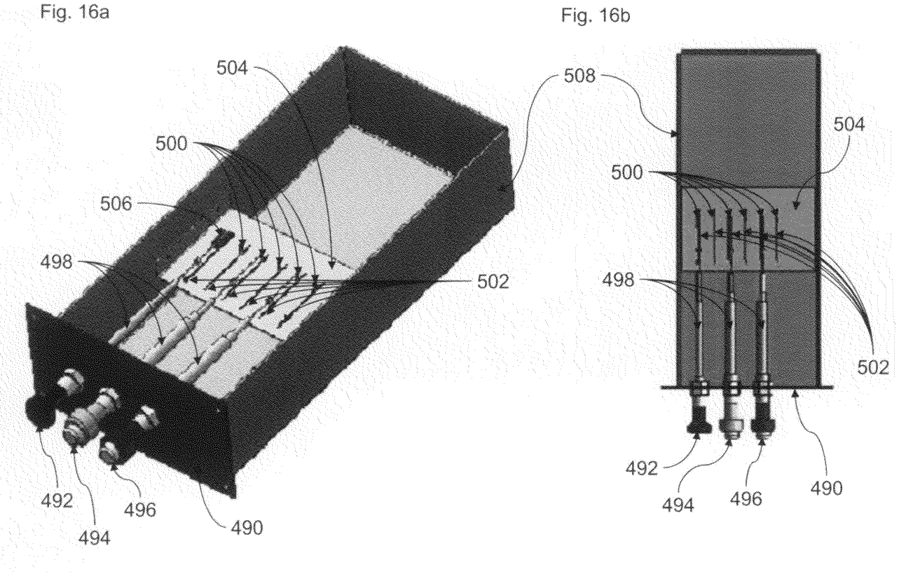

FIGS. 16a and 16b show an isometric and top view, respectively, of a single engine throttle quadrant without the top cover or front cover. This embodiment simulates a throttle quadrant for a single engine constant speed propeller aircraft. There are three push-pull style knobs (throttle 492, propeller pitch 494, and mixture 496) each coupled to a rod 498. The rods 498 are threaded through the face 490 and each is coupled to a slide potentiometer 500 with a pot arm clamp 506. The slide potentiometers 500 are attached to the underside of the pot support 504 and threaded through a slot 502 in the pot support 504. The pot support 504 is coupled to the tray 508. The potentiometers 500 are used to sense deflection of the rods 498. This deflection information is then transmitted to the computer for analysis and response. In the preferred embodiment the deflection information is transmitted via a USB connector and cable mounted at the rear of the tray 508. The tray 508 is engineered to be of the same width and depth regardless of the aircraft being simulated.

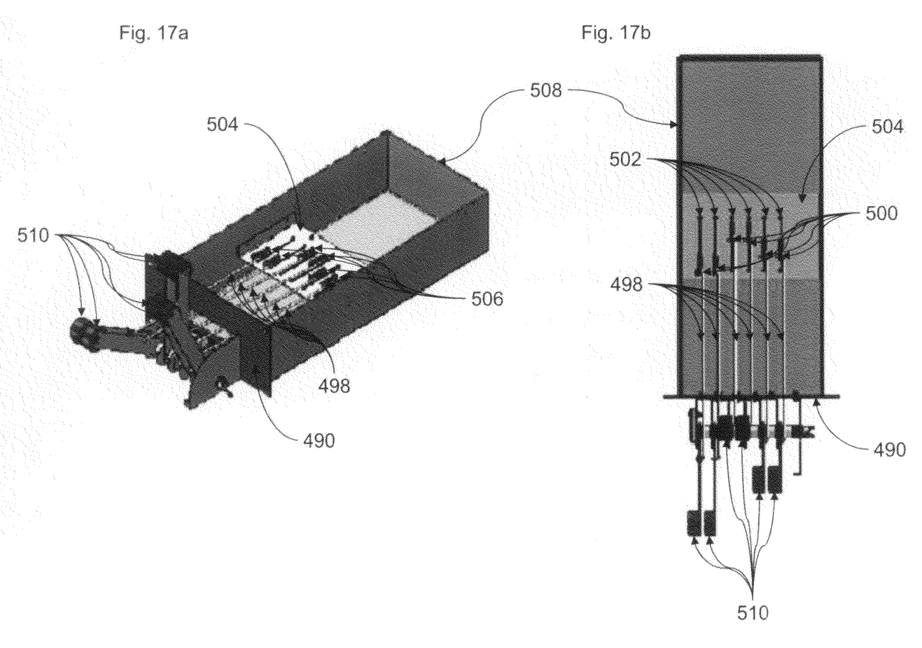

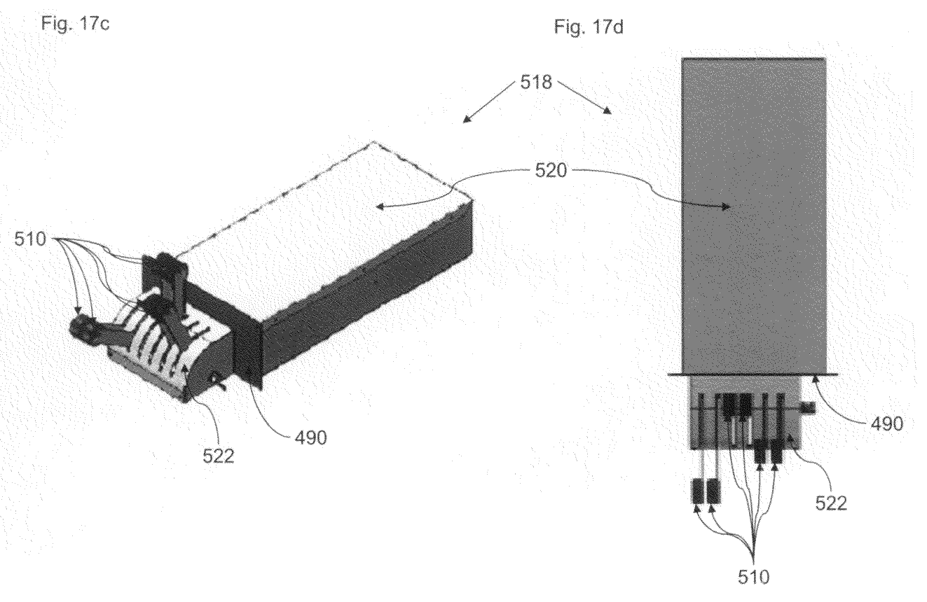

FIGS. 17a and 17b show an isometric and top view, respectively, of an alternate embodiment of the throttle quadrant without the top cover or front cover. This embodiment simulates a multi-engine aircraft. Instead of the push-pull style of knob, this embodiment uses a lever style control. As with the previous discussions, the levers 510 are coupled to rods 498 threaded through the face 490. The rods 498 are then coupled to potentiometers 500 with a pot arm clamp 506. The potentiometers 500 are threaded through slots 502 in the pot support 504 and the pot support 504 is coupled to the tray 508. It is important to note that, except for the style of knob (not shown) or lever 510 attached to the face 490, the internal workings of the throttle quadrant remain the same. This design facilitates the simulation of multiple kinds of aircraft by making different throttle quadrants easily exchangeable by only removing one throttle quadrant tray 508 for a different tray 508 having another configuration. Although only two embodiments are discussed, other combinations of levers, knobs, or other control structures could be substituted and accomplish the same results. FIGS. 17c and 17d show an isometric and top view of the alternate embodiment of the throttle quadrant 518 including the top cover 520 and front cover 522 installed.

### Yoke Assembly

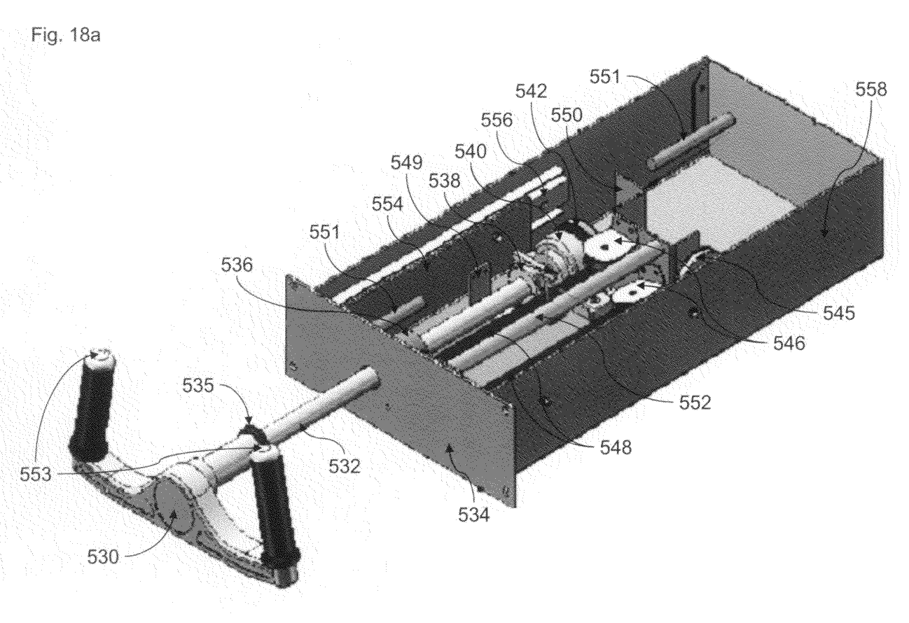

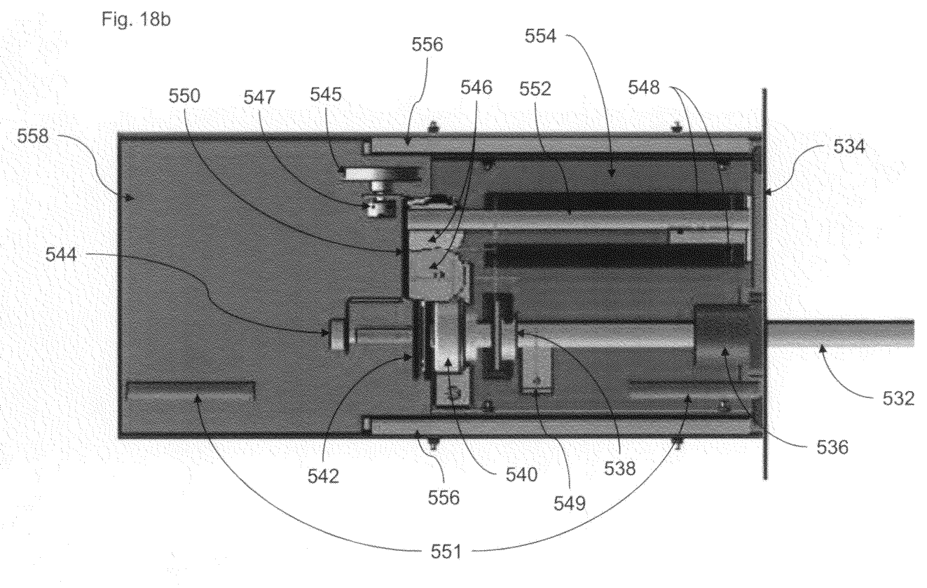

FIGS. 18a and 18b show isometric and top views, respectively, of the yoke assembly. This embodiment simulates a yoke style control. In a real aircraft the yoke 530 is used to control both the pitch and roll of the aircraft. The pitch of the aircraft is controlled by pushing the yoke 530 in or pulling the yoke 530 out. The roll of the aircraft is controlled by rotating the yoke 530 left or right. The yoke 530 is coupled to a shaft 532 which is threaded through a stop grommet 535, a face 534, and a bearing 536. The stop grommet 535 prevents over travel by the shaft 532. The shaft 532 passes through a collar 538. The collar 538 prevents the shaft 532 from being over-rotated. In the preferred embodiment, the collar 538 permits about 90° of rotation. The shaft 532 then passes through another bearing 540. The two bearings (536 and 540) maintain the shafts 532 proper alignment and provide smooth movement of the shaft 532. Next, the shaft 532 passes through the shaft pulley 542 and is finally coupled to the roll potentiometer 544. The shaft pulley 542 and roll potentiometer 544 are coupled to the shaft 532 such that when the shaft 532 is rotated, they both rotate. The shaft pulley 542 is attached to two roll pulleys 546. In the preferred embodiment, the roll pulleys 546 and the roll potentiometer 490 are mounted on a bracket 550 which is supported by a bracket support 552 to counteract the force of the roll springs 548. A band travels from the roll springs 548 through the roll pulleys and around the shaft pulley 542. When the shaft 532 is rotated, the band connecting the shaft pulley 542 to one of the roll springs 548 causes that roll spring 548 to be extended which creates a force in the opposite direction of rotation and allows the shaft 532 to return to a neutral position. If the shaft 532 was rotated the other direction, the other roll spring 548 would create the force to return the shaft 532 to a neutral position. Finally, as mentioned above, when the shaft 532 is rotated, so is the roll potentiometer 544. The roll potentiometer 544 measures the amount of rotation and this information is transmitted to a computer for analysis and response.

The bracket 550, bearing 540, and collar 538 are coupled to the pitch tray 554. The pitch tray 554 is coupled to rails 556 that allow the pitch tray 554 to slide within the yoke tray 558. As the shaft 532 is pushed or pulled, the pitch tray 548 slides along the rails 556. The pitch wheel 545 is coupled to the yoke tray 558 such that when the pitch tray 554 is moved, the pitch wheel 545 rotates along the yoke tray 558. In the preferred embodiment, the pitch wheel 545 has teeth and runs along a track with corresponding teeth mounted to the yoke tray 558. This ensures any movement of the pitch tray 554 causes a corresponding movement of the pitch wheel 545. The pitch wheel 545 is coupled to the pitch potentiometer 547 which is coupled to the bracket 550. The pitch potentiometer 547 measures the amount the pitch tray 554 has traveled and transmits the information to a computer for analysis and response. There are two pitch springs 551 coupled between the yoke tray 558 and the pitch bracket 549. The pitch bracket 549 is coupled to the pitch tray 554. When the pitch tray 554 is moved, one of the pitch springs 551 is stretched causing a force opposite to the direction of movement creating a force to return the pitch tray 554 back to a neutral position.

Additionally, buttons 553 can be added to the yoke 530 to add other functionality and realism (i.e. push-to-talk button, etc.). Also, in an alternative embodiment force feedback and/or haptic feedback could be employed to enhance the realism of the yoke. Force feedback and haptic feedback provide additional feedback to a user by adjusting the feel of the controls in response to certain actions. For example, as an aircraft is trimmed, less forward (or rear) pressure is needed on the yoke to maintain a certain pitch. Therefore, if force feedback or haptic feedback were implemented, as the trim in the simulator was adjusted, the pressure required on the yoke would also be adjusted. As another example, as an aircraft is taxiing and a gust of wind impacts the aircraft, a pilot in a real aircraft could feel the impact of the wind on control surfaces (e.g. rudder, elevator, ailerons) through the yoke and rudder pedals. As a final example, in a real aircraft, updrafts, downdrafts, and general turbulence can be felt by the pilot both in the physical movement of the aircraft and the forces applied to the control surfaces. Through force feedback and haptic feedback, these additional nuances could be delivered to the pilot through the yoke on the simulator. By implementing force feedback or haptic feedback, this realism could also be employed in the simulator.

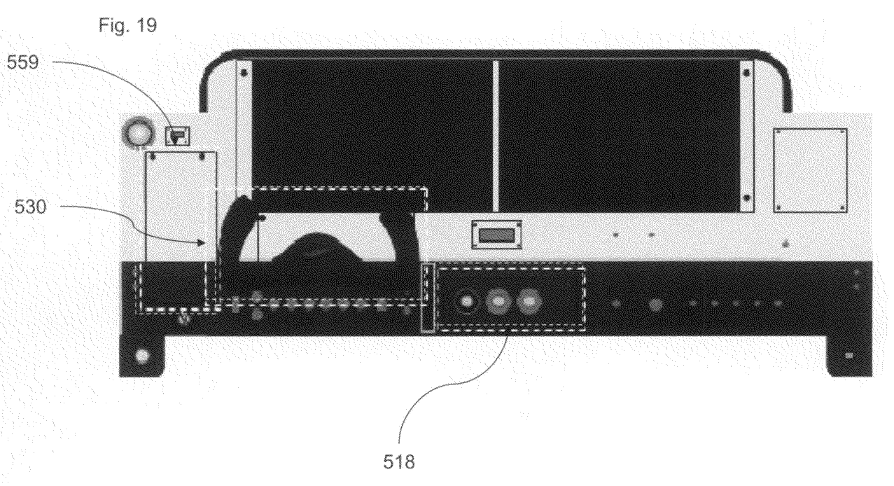

FIG. 19 depicts the yoke 530 and throttle quadrant 518 installed in the cockpit. In order to simulate a wider range of aircraft, in an alternative embodiment, the more traditional yoke 530 can be exchanged for a “stick” style yoke. The stick style yoke could pass through a door 559 or could be mounted on the floor generally positioned between the pilot's legs. Regardless, the stick style yoke would connect to a device similar to the yoke tray discussed above.

### Motion Platform

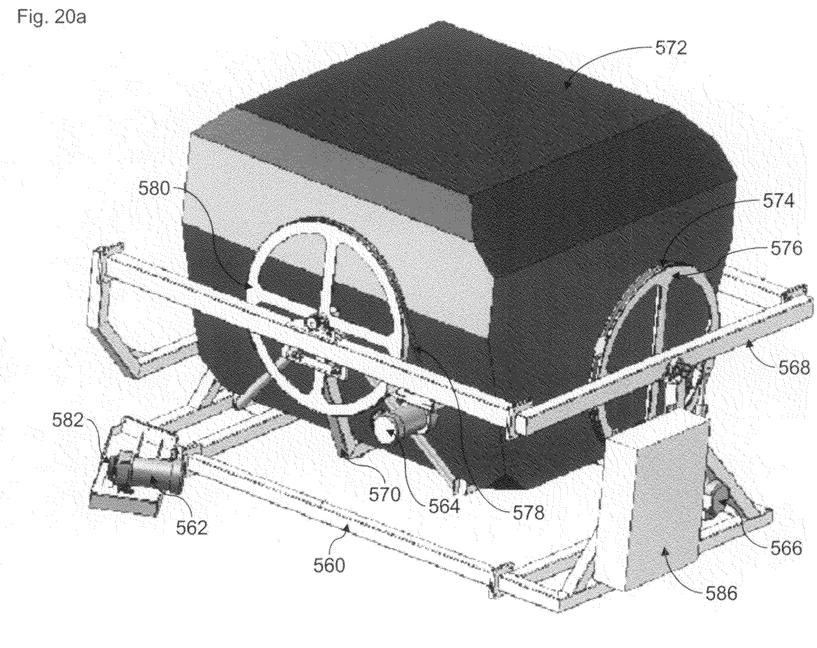

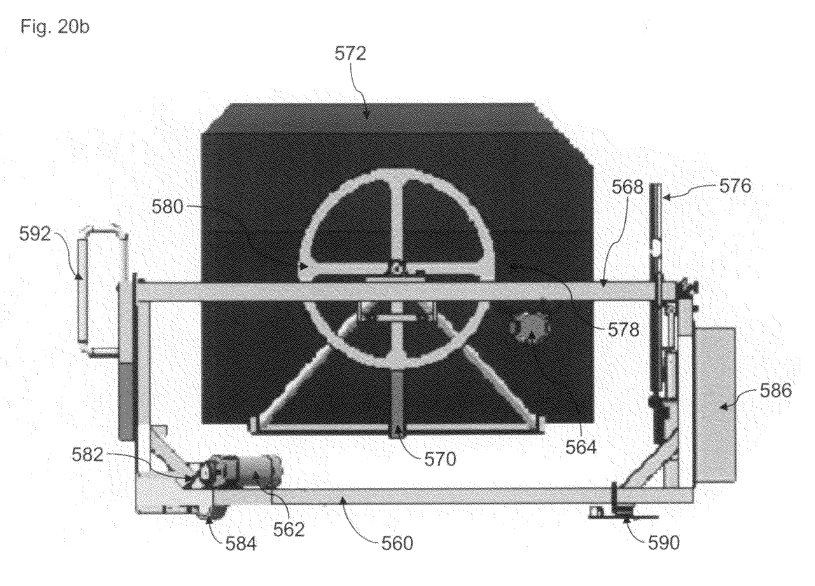

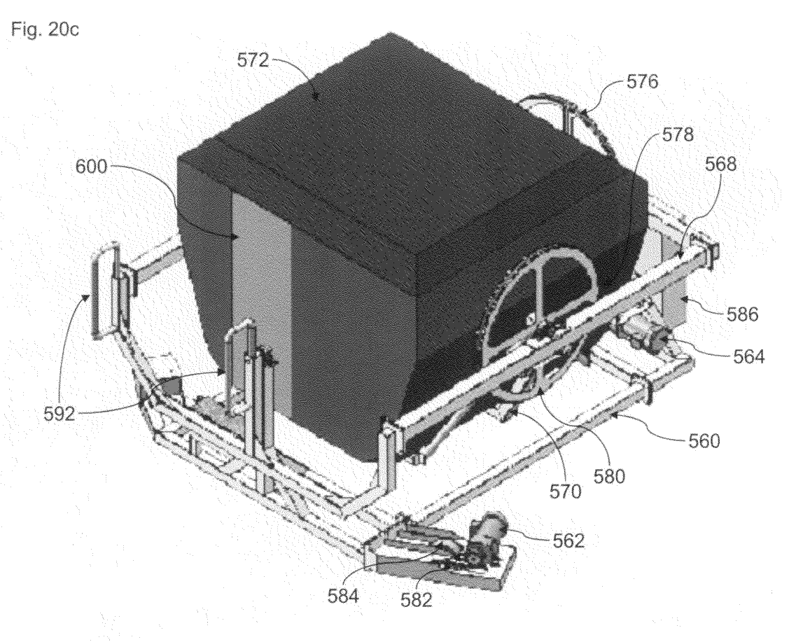

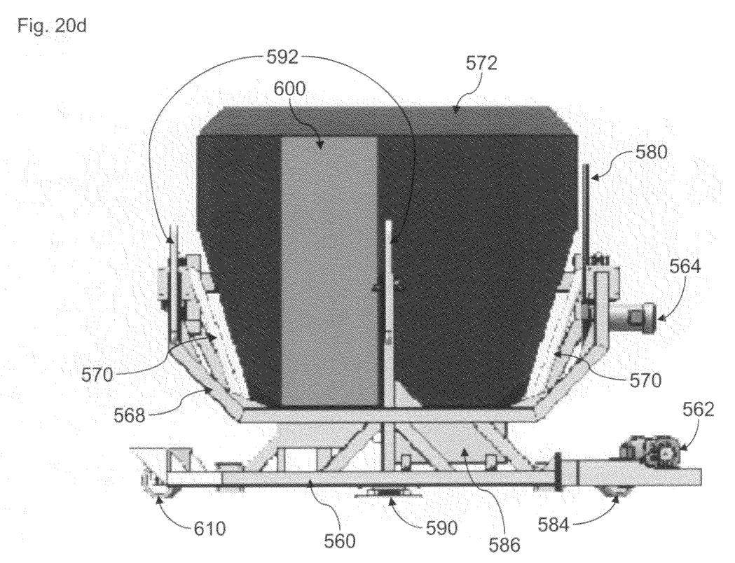

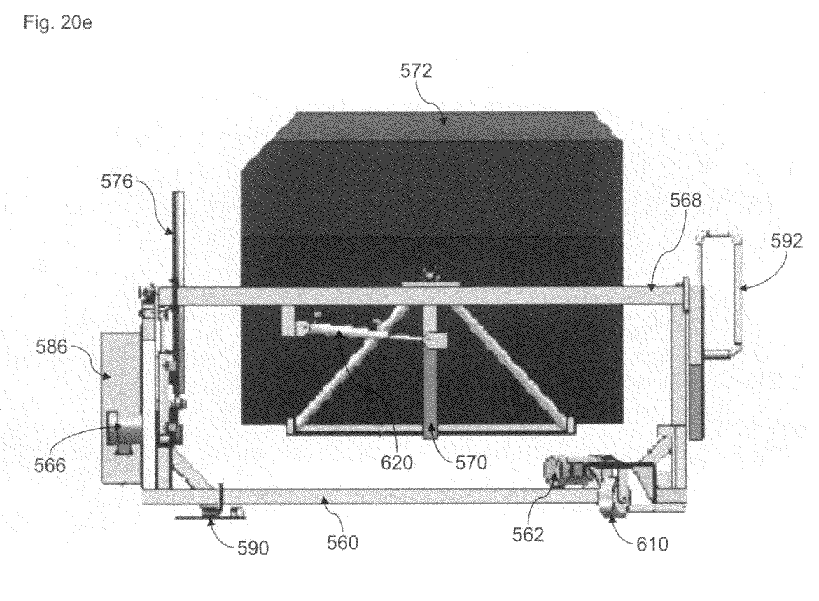

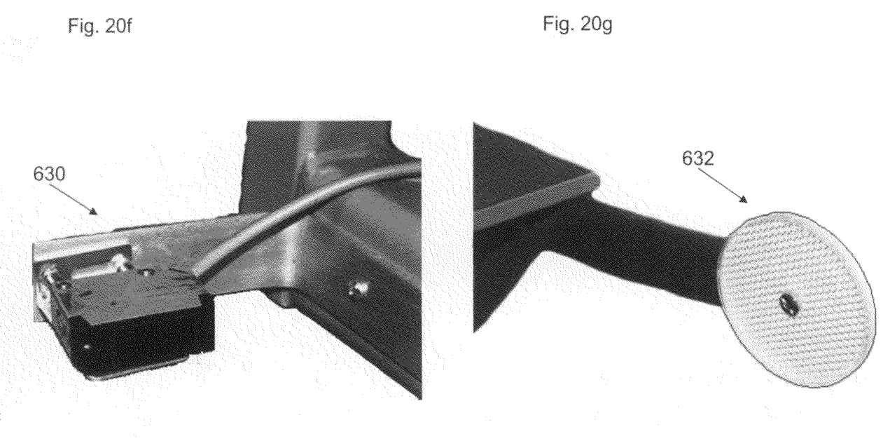

FIG. 20a shows an isometric view from the front right corner of the motion platform. The platform 560 rests on the floor and provides general support to the motion platform. The yaw motor 562 is coupled to the platform 560. The yaw motor 562 is also coupled to a yaw belt 582 which drives a drive wheel (not shown). Also coupled to the platform 560 is the roll motor 566. The roll motor 566 is coupled to a roll belt 574 which is coupled to a roll pulley 576 which is coupled to a roll frame 568. The roll frame 568 is pivotally coupled to the platform 560 such that when the roll motor 566 is activated, the roll belt 574 rotates the roll pulley 576 causing the roll frame 568 to roll left or right.

The pitch motor 564 is coupled to the roll frame 568. The pitch motor 564 is also coupled to a pitch belt 578 which is coupled to a pitch pulley 580. The pitch pulley 580 is coupled to the pitch frame 570. If present, the cockpit 572 is supported and coupled to the pitch frame 570. The pitch pulley 580 is pivotally coupled to the roll frame 568 such that when the pitch motor 564 is activated, the pitch belt 578 rotates the pitch pulley 580 causing the pitch frame 570 to pitch the cockpit 572 up or down.

When the yaw motor 562 is activated, the yaw belt 582 rotates the drive wheel (not shown) such that the rear of the platform 560 moves left or right. The front of the platform 560 remains stationary but pivots about the yaw bearing plate (not shown).

In the preferred embodiment, the entire motion platform is powered from one standard, single phase, 110 VAC, 15 amp power outlet. Traditionally, 230 VAC, three phase power was necessary for motion platforms; however, this was overcome with two innovations. First, the motion platform is balanced such that significantly less force is required to move/hold the frames in any direction. Second, variable frequency drives are used to convert the single phase 110 VAC to three phase 230 VAC power. Therefore, the motors are actually three phase 230 VAC motors but are ultimately powered by a single phase 110 VAC power outlet. This approach allows the standard power available at any office, shop, or other facility to power the entire motion platform.

The platform control system 586 receives and analyzes signals from a computer (not shown) and in response to those signals activates the various motors. Thus, by way of the yaw motor 562, the pitch motor 564, and the roll motor 566, the cockpit can simulate roll, pitch, heave, surge, yaw, and sway. This is a significant improvement previous motion platforms that required additional motors to simulate the same movements. In the preferred embodiment, the cockpit is permitted up to 50° of pitch movement, 40° of roll movement, and 60° of yaw movement; however, it would be clear to someone skilled in the art, with this disclosure, to provide more or less movement.

FIG. 20b depicts a right side view of the motion platform. In this view, it is easier to see the relation of the yaw motor 562, yaw belt 582, and the drive wheel 584 to each other and the yaw bearing plate 590. Again, when the yaw motor 562 is activated, the yaw belt 582 rotates the drive wheel 584 such that the rear of the platform 560 moves left or right. The front of the platform 560 pivots about the yaw bearing plate 590. Also seen in this view are the handles 592 which may be used by a student pilot to more easily step into the cockpit 572 (if attached). The remainder of the elements are labeled to provide a more clear understanding of the arrangement and functionality of the motion platform; however, their arrangement, interconnectivity, and function is as disclosed above.

FIG. 20c depicts an isometric view from the rear right corner of the motion platform. The door 600 provides access to the cockpit 572 (if attached) and may be closed to further immerse the student pilot into the simulation and reduce distractions. The remainder of the elements are labeled to provide a more clear understanding of the arrangement and functionality of the motion platform; however, their arrangement, interconnectivity, and function is as disclosed above.

FIG. 20d depicts a rear view of the motion platform. The idler wheel 610 is a passive wheel coupled to the platform 560. The idler wheel 610 merely follows the drive wheel 584 to provide smooth and level movement of the platform 560 when the yaw motor 562 is activated. The remainder of the elements are labeled to provide a more clear understanding of the arrangement and functionality of the motion platform; however, their arrangement, interconnectivity, and function is as disclosed above.

FIG. 20e depicts a left side view of the motion platform. The hydraulic lock 620 is coupled to both the pitch frame 570 and the roll frame 568. In the event the motion platform were to lose power, the hydraulic lock 620 is automatically engaged and prevents further pitch movement. Although not shown, there is also a hydraulic lock coupled between the roll frame and the platform to secure the cockpit from further roll movement. Note: because of the nature of the yaw movement, no hydraulic lock is necessary to restrict yaw movement. The hydraulic locks are engaged when the motion platform is paused to prevent the motion platform from moving. Also, if power were lost, the hydraulic locks automatically engage to secure the motion platform so pilots may safely enter or exit the cockpit. Additionally, although not shown, the preferred embodiment employs infrared beams on both the left and right side of the motion platform to identify when objects or persons are too close to the motion platform. FIG. 20f and 20g show pictures of the infrared transmitter and reflector, respectively, of the preferred embodiment. In the preferred embodiment, the infrared transmitters 630 are coupled to the front left and front right corners and directed towards reflectors 632 coupled near the idler wheel 610 (not shown) and the drive wheel (not shown). In the preferred embodiment, if a beam is broken further motion is disabled. In an alternative embodiment, if a beam is broken, motion is disabled for the motion platform in the direction of the broken beam and additional movement in the direction of the broken beam is inhibited. This safety feature helps to prevent objects or persons from coming into contact with the motion platform. Furthermore, the placement of the beam is desirable because the beam is positioned such that even when the motion platform yaws from left to right, the beam continues to provide a safety buffer around the motion platform. The remainder of the elements are labeled to provide a more clear understanding of the arrangement and functionality of the motion platform; however, their arrangement, interconnectivity, and function is as disclosed above.

Although FIGS. 20a-e were shown with the cockpit attached to the motion platform, the motion platform can operate independent of the cockpit.

### Instructor Software

The instructor software allows the instructor to interact and control the simulation.

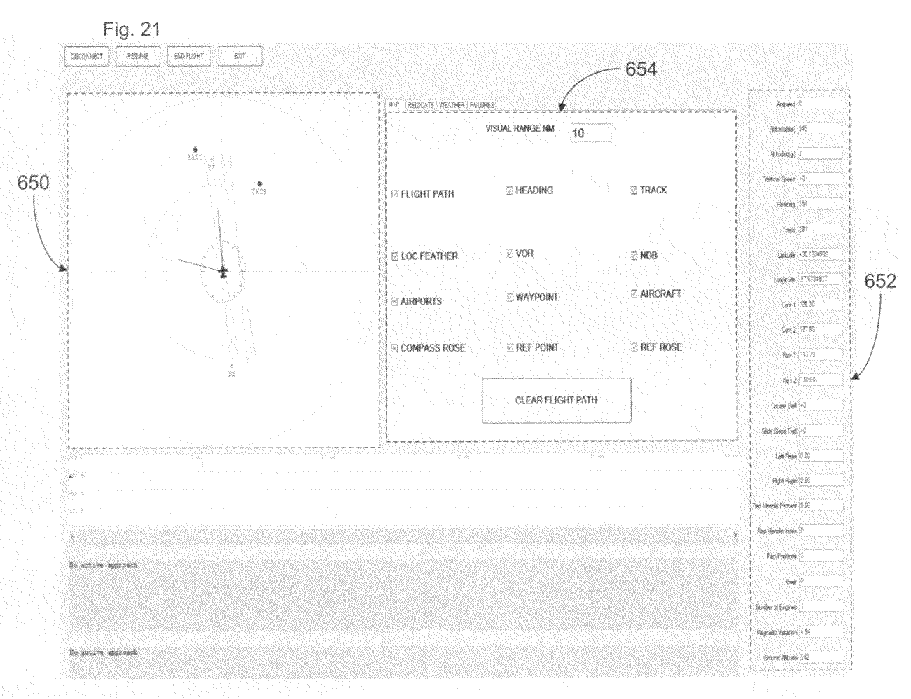

FIG. 21 depicts a screen shot of the map screen. The instructor is shown a moving map indicating the current positioning of the simulated aircraft 650. A series of information that depicts readings on the simulated aircraft also are shown 652. This information includes: airspeed, altitude, heading, track, radio and navigation frequencies, flaps position, landing gear position, and other variables important to operation and navigation. The map screen allows the instructor to customize the features displayed on the moving map 650 by adding or removing components 654. These components 654 range from tracking the flight path, heading, airport navigation localizer feathers, navigational NDB's (non-directional beacon) and VOR's (VHF Omni-directional Radio Beacon), and, among other things, the type of radial for point-and-click reposition of a flight.

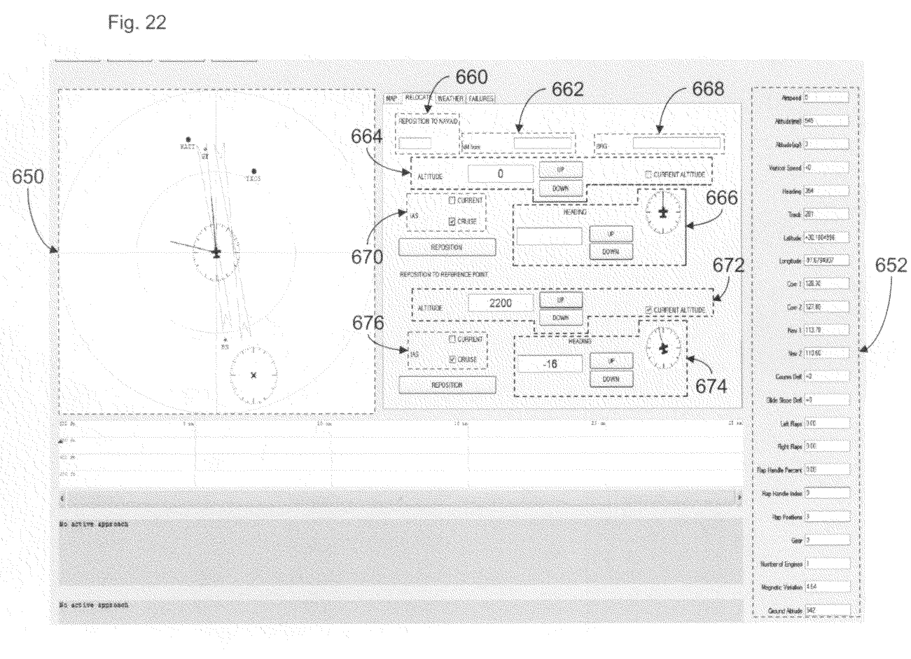

FIG. 22 depicts a screen shot of the relocate screen. The relocate screen is used to reposition an aircraft to a different position. Again, the moving map 650 and the informational readings 652 are displayed. There are two ways to accomplish the reposition. The first, allows the instructor to enter any valid ICAO (International Civil Aviation Organization) identifier 660 (e.g. an airport identifier such as KDFW for Dallas/Fort Worth International Airport) and reposition the flight to that location. Further, the instructor can reposition the aircraft a certain number of miles away from the ICAO identifier 662. Then the instructor may enter altitude 664, heading 666, bearing 668, and airspeed 670 if the instructor wishes to change from the current values.

The second way to reposition an aircraft is to click the point on the moving map 650 and the aircraft will be repositioned to the chosen point. Then the instructor may enter altitude 672, heading 674, bearing 668, and airspeed 676 if the instructor wishes to change from the current values. This feature is ideal for positioning the aircraft for repeated approaches and landings.

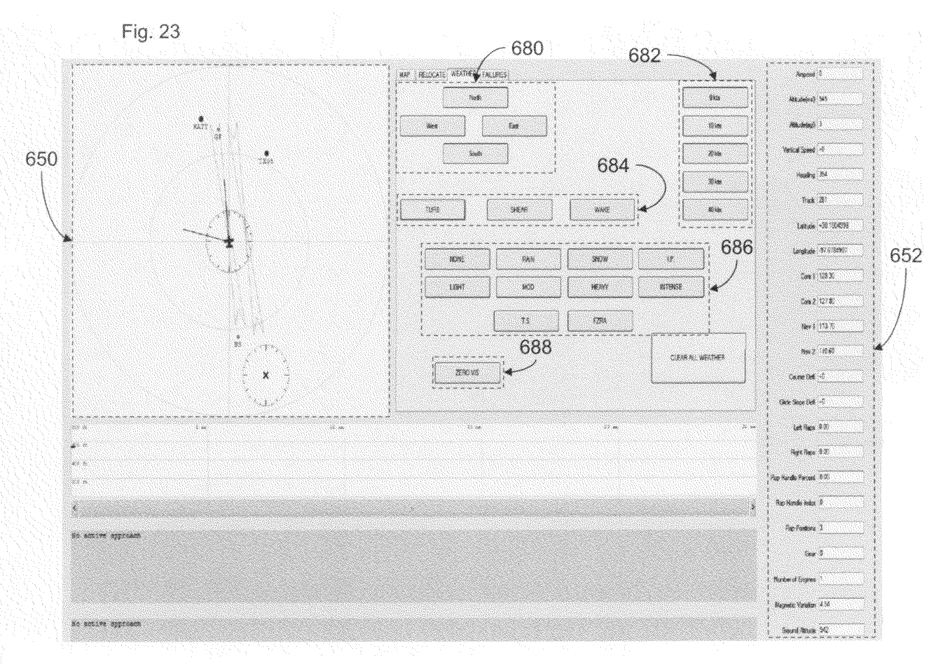

FIG. 23 depicts a screen shot of the weather screen. The weather screen allows the instructor to alter the current weather conditions. The instructor may change the wind direction 680, wind speed 682, wind/air anomalies (e.g. turbulence, wind shear, wake turbulence) 684, and precipitation type and intensity (e.g. rain, snow, ice pellets, thunderstorms, freezing rain, light, moderate, heavy, intense) 686. Finally, the instructor can lower the visibility to zero 688.

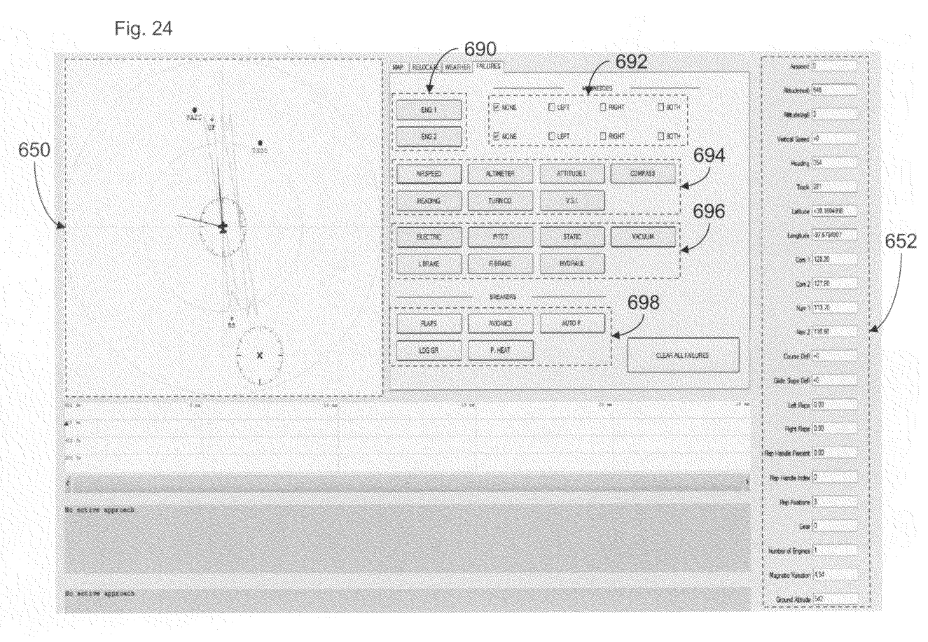

FIG. 24 depicts a screen shot of the failures screen. The failure screen allows the instructor to introduce abnormal events into the training scenario. The instructor may click any of the indicated buttons to invoke that particular failure into the simulation. The failures include complete engine failure 690 and/or just certain magnetos 692; individual gauges (e.g. airspeed, altimeter, attitude, heading, turn coordinator, vertical speed indicator, and compass) 694; individual components (e.g. electric, pilot, static, vacuum, left brake, right brake, hydraulics) 696; and individual breakers (e.g. flaps, avionics, auto pilot, landing gear, pitot heat) 698.

With all of the above (FIGS. 21-24), when the instructor issues the particular command, a signal is sent to the simulator to effectuate the command. For example, when the instructor clicks the flaps breaker, the flaps breaker in the simulator “pops” and the flaps are disabled until the student pilot rectifies the breaker. As another example, when the instructor clicks the vacuum failure button, all gauges in the simulator that rely on the vacuum (attitude, heading, turn coordinator) would fail or give anomalous results. As a final example, when the instructor clicks the rain button, rain appears on the displays in the simulator.

### Pilot Software

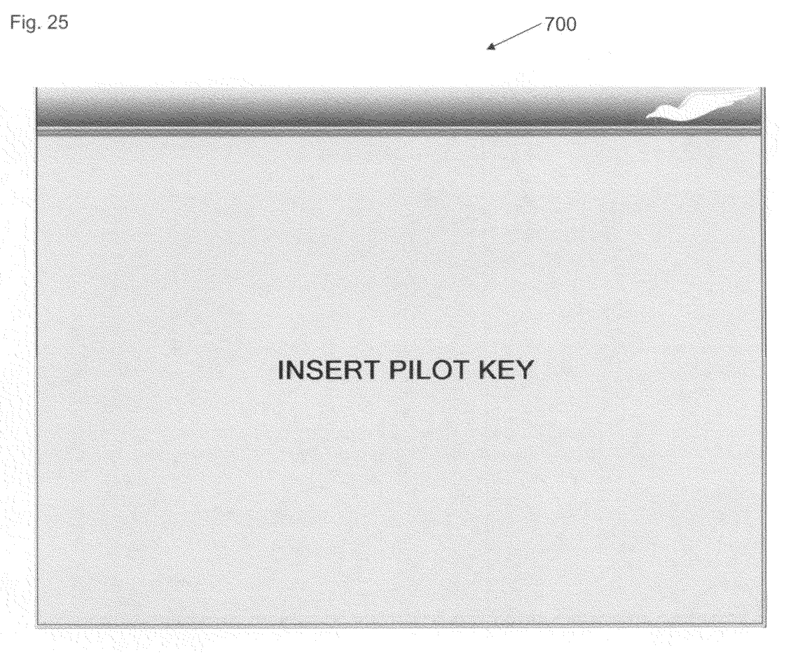

FIG. 25 depicts a screen shot of the opening screen. In the preferred embodiment, the opening screen is delayed about ten seconds upon initial system boot-up to allow other system functionality to be fully loaded prior to the opening screen being displayed. The opening screen 700 prompts the student pilot to insert their pilot key.

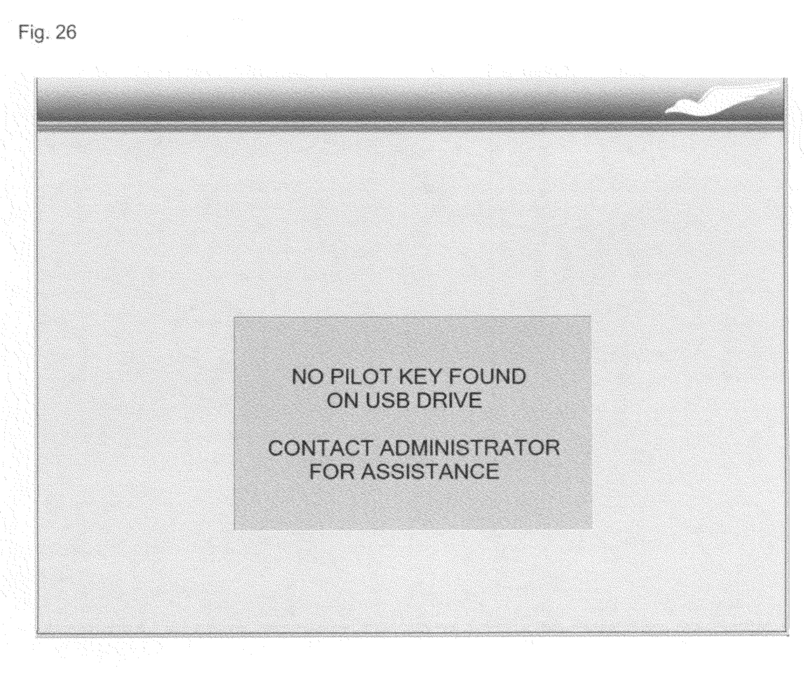

FIG. 26 depicts a screen shot of the invalid key screen. If a student pilot inserts an invalid pilot key, the system alerts the student pilot to seek assistance. As discussed in the pilot key section, the pilot key must contain a properly formatted and encrypted pilot record on it.

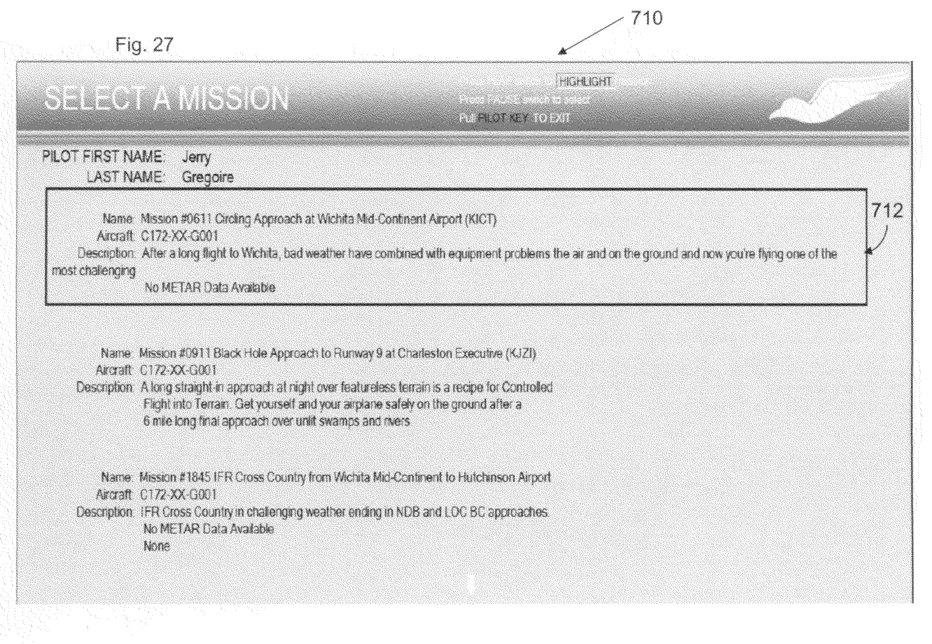

FIG. 27 depicts a screen shot of the mission select screen. Once a valid pilot key has been inserted, all of the authorized training scenarios on the pilot key are listed on the mission select screen 710. The student pilot selects the desired training scenario to begin that scenario. In the preferred embodiment, the student pilot selects a training scenario by moving the trim wheel up and down. Once the desired training scenario is outlined, the student would press the “pause” button to select the training scenario. Here, the student pilot has selected “Mission #0611 Circling Approach at Wichita Mid-Continent Airport (KICT)” 712.

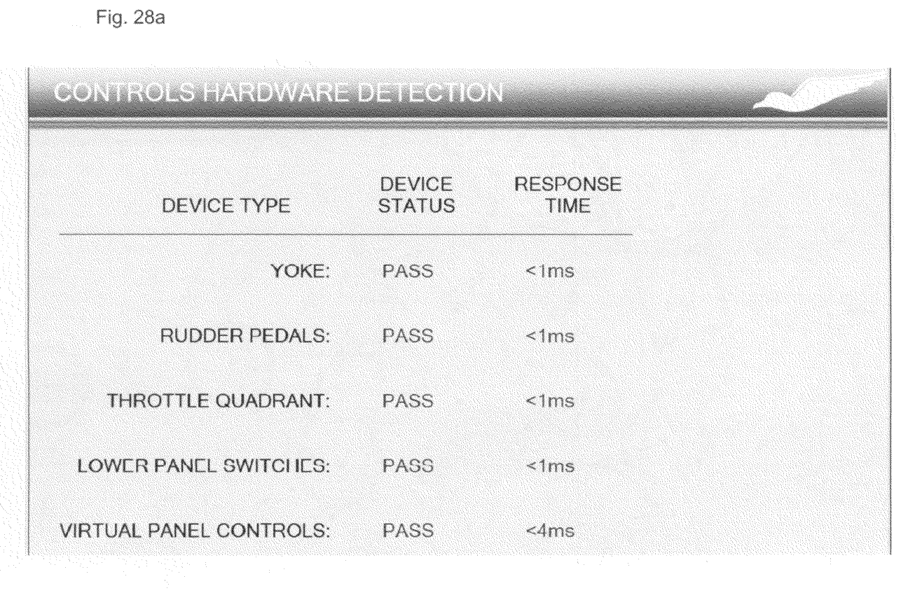

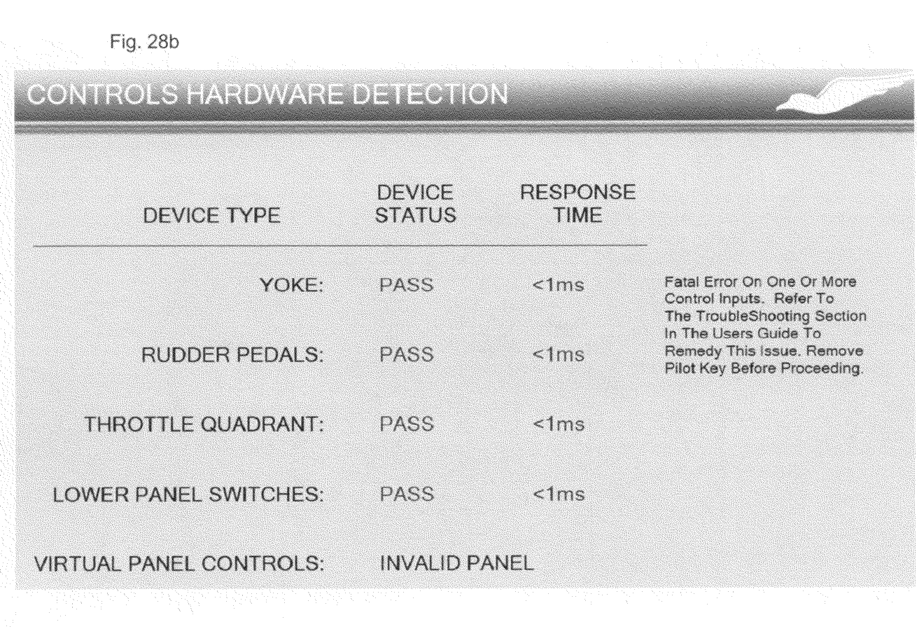

The simulator then performs a hardware detection cycle. The FAA requires the system to undergo a self-check to ensure all externally connected devices are both operational and performing to minimum specifications prior to each use of the simulator. In this case, the system is required to verify that all externally connected devices have a response time of less than 30 milliseconds. If there are no failures, the student pilot is notified and the system proceeds to launch the training scenario. FIG. 28a depicts a screen capture of the system passing the self-check. If, however, the yoke, throttle quadrant, rudder pedals, and/or acrylic panel are not functioning properly, the system will alert the user to the failure. FIG. 28b depicts a screen capture of the system failing the self-check. In the preferred embodiment, the failure screen remains visible until the pilot key is removed or the failure is corrected.

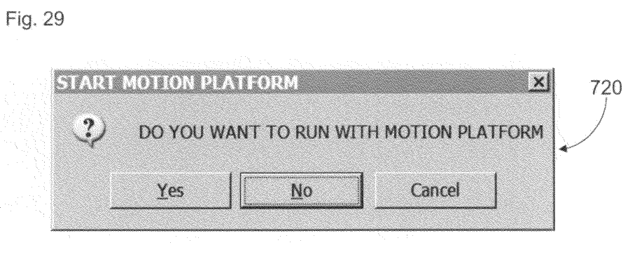

After the system passes the self-check, the student pilot is asked whether to run the training scenario with the motion platform. FIG. 29 depicts a screen capture of the start motion platform query 720.

### Motion Platform Interface

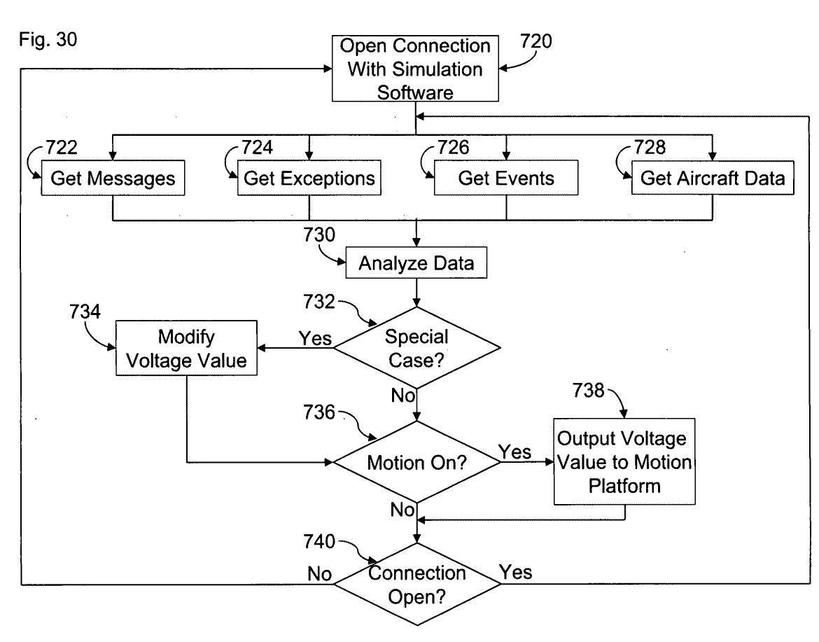

FIG. 30 depicts a flow diagram for the motion platform interface. First, the motion platform interface must open a connection with the simulation software 720. In the preferred embodiment, the simulation software is Microsoft's™ ESP. Further, in the preferred embodiment the connection to ESP is achieved through the Simconnect API. Regardless of how the connection is achieved, the motion platform interface polls the simulator software for messages 722, exceptions 724, events 726, and aircraft data 728 (collectively, the data). Messages 722 can include items such as whether a connection to the simulator has been established or not. Exceptions 724 are generally information on errors. Events 726 can include items such as pause, unpaused, and crashed. Finally, the aircraft data 728 includes the vital statistics on the aircraft including: ground velocity, acceleration in the X-axis, acceleration in the Y-axis, acceleration in the Z-axis, whether the aircraft is on the ground or in the air, and whether the aircraft is stalling.

The motion platform interface takes all of the data and analyzes it to evaluate a set of voltage values. The motion platform interface first converts the X, Y, and Z-axis acceleration data 728 to voltage values for use with the motion platform. The motion platform interface then determines if the data indicates any special cases 732. Special cases 732 could include landing, taking off, stalling, turbulence, and/or crashing. If there is a special case 732, the voltage values are modified further to account for the special case. For example, if the simulated aircraft was landing, the motion platform interface would modify the voltage values so the motion platform would mimic a bump or jolting as the landing gear came in contact with the ground. Provided the motion feature is turned on 736, the voltage values are sent to the motion platform 738. Before repeating, the motion platform interface verifies the connection to the simulation software is still open 740. If the connection is not open, it is reopened 720 and the messages 722, exceptions 724, events 726, and aircraft data 728 are obtained again. In the preferred embodiment, this process is repeated 100 times per second.

Although described herein as a series of sequential steps, those skilled in the art will appreciate the steps can be performed in a different order and/or in parallel. Furthermore, those skilled in the art will appreciate that the particular voltage values output to the motion platform and the modifications for certain events will depend on the particular motion platform solution employed. In the preferred embodiment, the voltage values range from: one to nine for pitch, one to nine for roll, and two to eight for yaw. Furthermore, in the preferred embodiment, the modifications for landing are to decrease the pitch voltage value by two and the yaw voltage value by one; and the modifications for stalling are to decrease the yaw voltage value by two. There are no modifications for takeoff; however, the pitch voltage value is kept constant to guard against the motion platform pitching the nose down.

### Motion Platform Firmware

When the motion platform is installed, the limits of movement in the roll, pitch, and yaw directions must be calibrated. Calibration is accomplished by each axis being moved to its respective travel limits one at a time (e.g. for roll, all the way to the left, then all the way to the right). Once the travel limits are reached, each axis position is saved. The position of the roll and pitch axis are determined by reading a potentiometer attached to each axis. The position of the yaw axis is determined by reading a quadrature encoder. A quadrature encoder is a device affixed onto the axle of a wheel which determines the amount and direction of movement of the axle. Therefore, there are six axis positions stored: roll left, roll right, pitch forward, pitch backwards, yaw left, and yaw right (collectively, the “operational envelope”). This calibration is only required during initial install or if some piece of hardware is replaced or repaired. After calibration, routine operation may begin.

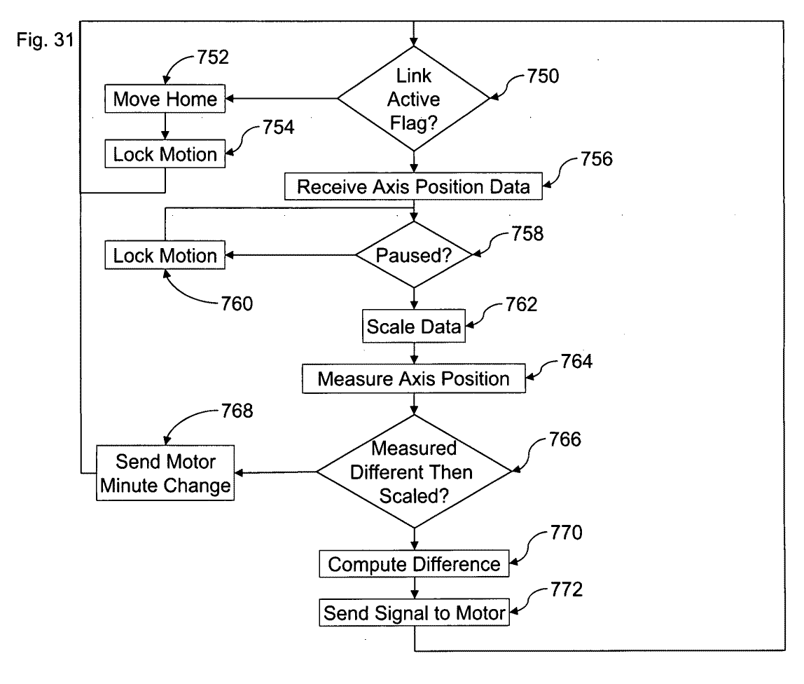

FIG. 31 depicts a flow chart of the routine operation of the motion platform firmware. In the preferred embodiment, the motion platform firmware is connected to a computer via ethernet. The connection between the motion platform firmware and the controlling computer is monitored to ensure the link is active 750. If the link is not active, the firmware sends signals to the various motors to return the motion platform to its home position 752 and lock the motion 754. The home position is the half way point between the travel limits for each axis. The motion platform is locked via hydraulic cylinders (one locking pitch movement—pitch frame lock and another locking roll movement—roll frame lock) which, once engaged, prevent the motion platform from moving. In the preferred embodiment, the hydraulic cylinders are a failsafe—if the power is removed, the hydraulic cylinders lock and the motion platform will no longer move. This allows users to enter and exit the motion platform safely in the event of a power failure or other anomaly.

Provided the link is active, the firmware receives the axis position from the controlling computer 756. The firmware then determines if the motion platform has been paused 758 and if so, locks the motion platform 760 in the current position until the motion platform is unpaused. If the motion platform has not been paused, the firmware scales the received axis positions 762. The received axis positions are scaled to the operational envelope of the motion platform. This makes it impossible for the motion platform to move outside its operational envelope. Furthermore, in the preferred embodiment additional failsafes are added to prevent the motion platform from moving outside its operational envelope such as: the firmware compares the current position to the travel limits and stops the motion at the travel limits; if the travel limits are reached and the motors continue to attempt to move the motion platform beyond the travel limits, the belts will slip. After scaling 762, the firmware reads the current axis positions of the motion platform 764 and compares the read positions for each axis with the scaled data 766 for each axis. If there is no difference for a particular axis, then a minor change is sent to the motor for that axis 768. The minor change causes the axis to wander at very slow speed around the desired position and maintains axis control.

If there is a difference between the read position and the scaled data for a particular axis, a signal is sent to that axis' motor 772 to turn in a particular direction until there is no longer a difference. The speed at which the axis is moved depends on the difference between the desired positioning and the current position. The larger the difference, the quicker the motion platform moves to the desired position. In the preferred embodiment, if the controlling computer 756 wants the axis to be moved a large distance at a slower speed, the controlling computer will transmit a series of axis positions that have a small difference between the desired position and the current position. Regardless of the speed, as the axis gets closer to the scaled data position, the axis slows down. In the preferred embodiment, the entire process is repeated about 100 times per second.

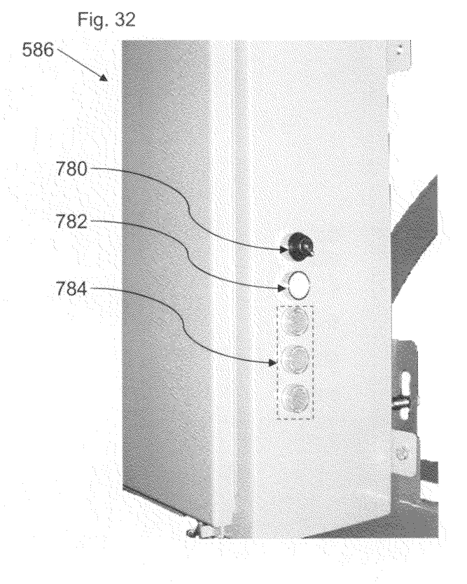

In addition to the above, the motion platform firmware also monitors and reports any faults in the motion platform. Some of the faults monitored are: failure of the PCB containing the firmware (e.g. memory, input/output, communication, watchdog timeout, logic, etc.); diagnostic error; motor errors (e.g. motor faults, motor failed to run, opposite travel limits realized at same time, travel limit on at wrong time); and sensor/encoder failures (e.g. yaw shaft encoder, pitch sensor, roll sensor). FIG. 32 depicts the platform control system. In the preferred embodiment, if a fault is identified a series of lights 784 will indicate the fault failure code. The motion platform would lock and cease normal operation until the fault is remedied and power is cycled.

To assist in calibration, configuration, and testing, the motion platform firmware has eight service modes. In the preferred embodiment, the service modes are activated by a keyed switch 780 and a toggle switch 782. The service modes include: calibrate yaw axis, calibrate pitch axis, calibrate roll axis, test yaw axis, test pitch axis, test roll axis, lock pitch and roll, and fault reset. Normally, the keyed switch 780 is set to normal operation and the toggle switch 782 has no function until the keyed switch 780 is placed in service mode. The keyed switch 780 is intended to restrict access to the service mode to only authorized personnel.

### Cockpit

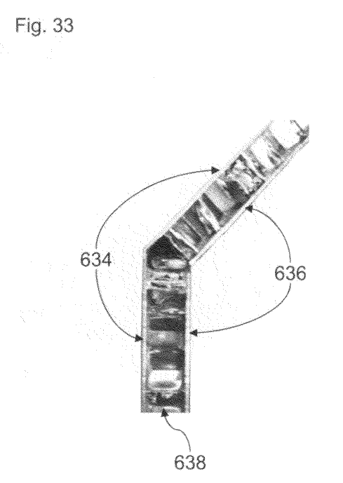

The cockpit brings together many of the components and represents the cockpit of the simulated aircraft. In the preferred embodiment, the cockpit is made out of a lightweight aluminum. Generally, sheets of aluminum are not strong enough or structurally rigid enough to support the weight and movement required of a motion flight simulator. This was overcome by creating a corrugated/honeycombed style aluminum. FIG. 33 depicts a cross sectional view of the corrugated/honeycombed aluminum. An outer sheet 634 and inner sheet 636 enclose the corrugated/honeycombed aluminum 638. By corrugating/honeycombing the aluminum, significant structural support is achieved without a significant increase in weight.

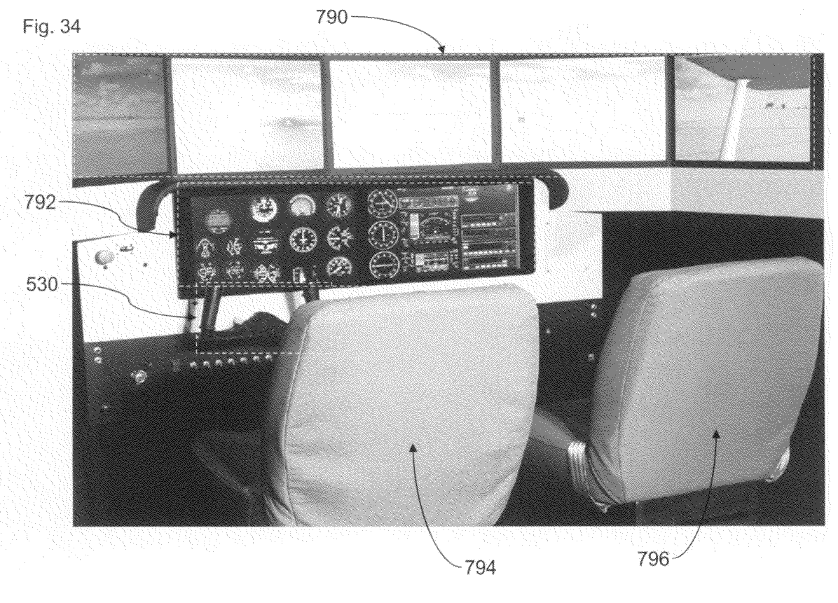

FIG. 34 shows an exemplary cockpit. The major components of the cockpit are: a series of external view visual displays 790 showing simulated external views through the cockpit of the simulated aircraft; an interchangeable instrument panel (also referred to throughout as an acrylic panel or acrylic overlay) affixed over instrument visual displays 792 showing the simulated instruments; the yoke 530; rudder pedals (not shown); throttle quadrant (not shown); a left chair 794; and a right chair 796. In the preferred embodiment, the chairs (794 and 796) slide forward and backwards to accommodate a wider array of student pilots.

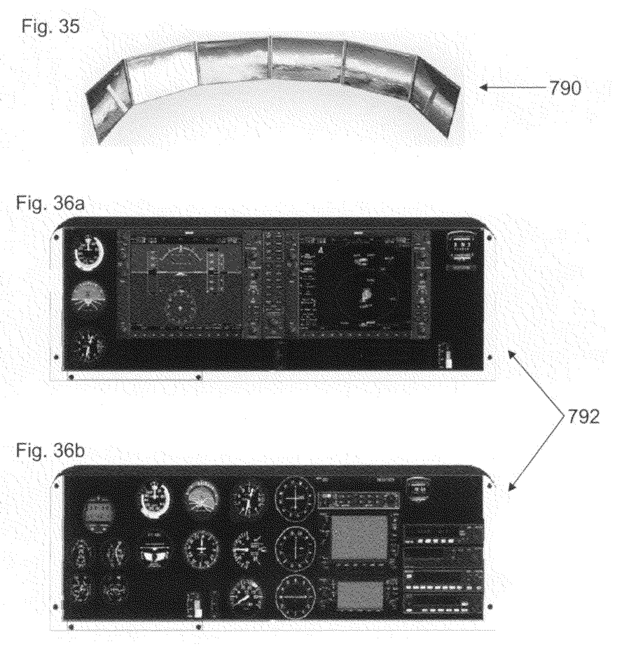

FIG. 35 depicts the external view visual displays 790 showing simulated external views. In the preferred embodiment, six LCDs arranged in a curved wrap around style are used for the external view visual displays. This arrangement both enhances the realism and better simulates a real aircraft. By utilizing the wrap around configuration, a significantly greater amount of the student pilot's visual range (e.g. including peripheral vision) is used.

FIG. 36a depicts one embodiment of the interchangeable instrument panel affixed over the instrument visual displays 792 displaying the instruments customarily found in an aircraft with glass panel instrumentation. FIG. 36b depicts another embodiment of the interchangeable instrument panel affixed over the instrument visual displays 792 displaying the more traditional six pack and avionics stack.

Those with skill in the arts will recognize that the disclosed embodiments have relevance to a wide variety of areas in addition to those specific examples described above.

What is claimed is:

1. A simulated instrument panel for a flight simulator, said simulated instrument panel comprising:
at least one panel, said panel simulating a particular aircraft;
a plurality of controls coupled to said panel in the approximate location and of approximately the same type as said controls in said particular aircraft;
a control system communicably coupled to said controls, said control system capable of accepting a user's actions via said controls.

2. The simulated instrument panel of claim 1, said panel interchangeable by an end user.

3. The simulated instrument panel of claim 1, said controls comprising knobs, switches, and buttons for at least:
a communications radio;
a navigation radio;
a transponder;
an attitude indicator; and
a heading indicator.

4. The simulated instrument panel of claim 3, said panel interchangeable with a panel simulating another particular aircraft.

5. The simulated instrument panel of claim 4, said panel coupled to at least one instrument visual display, said instrument visual display communicably coupled to said control system, said control system additionally capable of:
displaying simulated instruments on said instrument visual displays, said simulated instruments corresponding to said controls and including:
said communications radio;
said navigation radio;
said transponder;
said attitude indicator;
said heading indicator; and
changing said simulated instruments in response to said user's actions.

6. The simulated instrument panel of claim 1, said panel constructed predominantly of acrylic.

7. The simulated instrument panel of claim 1, said controls comprising at least one of knobs, switches, and buttons for an all glass avionics suite.

8. The simulated instrument panel of claim 7, said panel coupled to at least one instrument visual display, said instrument visual display communicably coupled to said control system, said control system additionally capable of:
displaying a simulated all glass avionics suite on said instrument visual displays, said simulated all glass avionics suite corresponding to said controls; and
changing said simulated all glass avionics suite in response to said user's actions.

9. The simulated instrument panel of claim 7, said panel interchangeable with a panel simulating another particular aircraft.

10. The simulated instrument panel of claim 9, said panels having the same basic form factor.

11. The simulated instrument panel of claim 1, said panel interchangeable with a panel simulating another particular aircraft.

12. The simulated instrument panel of claim 11, said panels having the same basic form factor.

13. The simulated instrument panel of claim 1, said panel coupled to at least one instrument visual display, said instrument visual display communicably coupled to said control system, said control system additionally capable of:
displaying simulated instruments on said instrument visual displays, said simulated instruments corresponding to said controls; and
changing said simulated instruments in response to said user's actions.
